(19) United States
(12) Patent Application Publication
(10) Pub. No.: US 2025/0261175 A1
(43) Pub. Date: Aug. 14, 2025

(54) COMMUNICATION APPARATUS AND COMMUNICATION METHOD FOR FEEDBACK RESPONSE TRANSMISSION IN INDICATED FREQUENCY DOMAIN

(71) Applicant: Panasonic Intellectual Property Corporation of America, Torrance, CA (US)

(72) Inventors: Yanyi DING, Singapore (SG); Rojan CHITRAKAR, Singapore (SG); Yoshio URABE, Nara (JP); Hiroyuki MOTOZUKA, Kanagawa (JP)

(21) Appl. No.: 18/859,495

(22) PCT Filed: Mar. 31, 2023
(86) PCT No.: PCT/SG2023/050222

§ 371 Date: Oct. 23, 2024

(30) Foreign Application Priority Data
Apr. 28, 2022 (SG) 10202204601U

(51) Int. Cl. H04W 72/0453; H04W 72/121; H04W 72/1263

(52) U.S. Cl. CPC H04W 72/0453; H04W 72/121; H04W 72/1263

(57) ABSTRACT

The present disclosure provides a communication apparatus and a communication method for a feedback response transmission in an indicated frequency domain, the communication apparatus comprising: circuitry, which, in operation, generates a signal that solicits a feedback response; and a transmitter, which, in operation, transmits the generated signal to one or more peer communication apparatuses, wherein the generated signal comprises frequency domain information indicating a frequency domain used for transmitting the feedback response within an operating channel of the one or more peer communication apparatuses.

### TECHNICAL FIELD

The present disclosure relates to communication apparatuses and methods for transmission of a feedback response, and more particularly for a feedback response transmission in an indicated frequency domain.

### BACKGROUND

In the standardization of next generation wireless local area network (WLAN), a new radio access technology necessarily having backward compatibilities with IEEE 802.11a/b/g/n/ac/ax technologies has been discussed in the IEEE 802.11 Working Group and is named IEEE 802.11be Extremely High Throughput (EHT) WLAN.

In 802.11ax EHT WLAN, a null data packet (NDP) feedback report procedure is used and allows an High Efficiency (HE) access point (AP) to collect feedback that is not channel sounding (e.g., buffer status, power status) from multiple non-AP HE stations (STAs) to improve 802.11ax efficiency especially in high density environment.

However, in some scenarios such as non-Subchannel Selective Transmission (non-SST) scenario, where all non-AP STAs park on the primary frequency segment and listen to the primary channel, if the bandwidth of the trigger-based feedback NDP is not proper, some non-AP STAs may not be able to participate in the feedback response transmission. Furthermore, even the supported number of STAs in a 20 MHz may be enough in 802.11ax, in 802.11be or future amendments, a support for higher density environment will be required.

Besides, in Subchannel Selective Transmission (SST) scenario, where 20/80/160 MHz non-AP STAs can participate transmission or reception with larger bandwidth in a secondary 20/80/160 MHz channel. According to the SST operation limitation, the non-AP STAs may be not able to participate the NDP Feedback Report procedure with any bandwidth of the trigger-based feedback NDP.

There is thus a need for communication apparatuses and methods that provide feasible technical solutions to address the issues, more particularly, to realize a feedback response transmission in an indicated frequency domain within its operating channel to ensure all non-AP STAs can participate in the feedback response.

Furthermore, other desirable features and characteristics will become apparent from the subsequent detailed description and the appended claims, taken in conjunction with the accompanying drawings and this background of the disclosure.

### SUMMARY

Non-limiting and exemplary embodiments facilitate providing communication apparatuses and communication methods for a feedback response transmission in an indicated frequency domain in context of EHT WLAN.

In a first aspect, the present disclosure provides a communication apparatus comprising: circuitry, which, in operation, generates a signal that solicits a feedback response; and a transmitter, which, in operation, transmits the generated signal to one or more peer communication apparatuses, wherein the generated signal comprises frequency domain information indicating a frequency domain used for transmitting the feedback response within an operating channel of the one or more peer communication apparatuses.

In a second aspect, the present disclosure provides a peer communication apparatus comprising a receiver, which, in operation, receive a signal to solicit a feedback response, the signal comprising frequency domain information indicating a frequency domain used for transmitting the feedback response within an operating channel of the peer communication apparatus; circuitry, which, in operation, process the signal and generate the feedback response; and a transmitter, which, in operation, transmit the feedback response in the frequency domain.

In a third aspect, the present disclosure provides a communication method implemented by a communication apparatus comprising: generating a signal used for soliciting a feedback response; transmitting the signal to one or more peer communication apparatuses, the signal comprising frequency domain information indicating a frequency domain used for transmitting the feedback response within an operating channel of the peer communication apparatuses.

In a fourth aspect, the present disclosure provides a communication method implemented by a peer communication apparatus comprising: receiving a signal to solicit a feedback response, the signal comprising frequency domain information indicating a frequency domain used for transmitting the feedback response within an operating channel of the peer communication apparatus; processing the signal and generating the feedback response; and transmitting the feedback response in the frequency domain.

It should be noted that general or specific embodiments may be implemented as a system, a method, an integrated circuit, a computer program, a storage medium, or any selective combination thereof.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

Embodiments of the disclosure will be better understood and readily apparent to one of ordinary skilled in the art from the following written description, by way of example only, and in conjunction with the drawings, in which:

FIG. 1 depicts a schematic diagram of downlink Multi-User (MU) communication between an access point (AP) and multiple stations (STAs).

FIG. 2 depicts a schematic diagram of trigger-based uplink MU communication between an AP and multiple STAs.

FIG. 3A shows a format of a HE PPDU 300 used for downlink MU communications between an AP and multiple STAs in a HE WLAN, e.g. OFDMA transmission.

FIG. 3B shows a format of a HE PPDU 320 used for uplink MU communications between an AP and multiple STAs in a HE WLAN.

FIG. 4A shows a format of The EHT PPDU 400 used for downlink MU communications between an AP and multiple STAs in an EHT WLAN.

FIG. 4B depicts a format of an EHT PPDU 420 used for uplink MU communications between an AP and multiple STAs in an EHT WLAN.

FIG. 5 depicts a diagram illustrating a null data packet (NDP) feedback report procedure.

FIG. 6 depict a format of a NFRP Trigger frame in FIG. 5.

FIG. 7 depicts a diagram illustrating a mapping of RU tone sets from different RU tone set indices to an HE-LTF symbol(s) of the HE TB Feedback NDP.

FIG. 8 depicts a diagram illustrating an example NDP Feedback report procedure in a 40 MHz channel in a non-SST scenario.

FIG. 9 depicts a diagram illustrating more than one round of NDP Feedback report procedure in a 40 MHz channel in a non-SST scenario.

FIG. 10 depicts a diagram illustrating an example NDP Feedback report procedure in a 40 MHz channel in a SST scenario.

FIG. 11 depicts a 40 MHz TB Feedback NDP and a 20 MHz TB Feedback NDP for transmitting a feedback response in a non-SST scenario.

FIG. 12 depicts a schematic, partially sectioned view of a communication apparatus according to the present disclosure.

FIG. 13 shows a flow diagram illustrating a communication method implemented by a base communication apparatus according to various embodiments of the present disclosure.

FIG. 14 shows a flow diagram illustrating a communication method implemented by a peer communication apparatus according to various embodiments of the present disclosure.

FIG. 15 depicts an example format of EHT TB Feedback NDP according to an embodiment of the present disclosure.

FIG. 16 depicts an example format of an EHT NFRP Trigger frame according to another embodiment of the present disclosure.

FIG. 17 depicts an example format of an EHT NFRP Trigger frame according to a first embodiment of the present disclosure.

FIG. 18 depicts a diagram illustrating an example NDP Feedback report procedure according to the first embodiment of the present disclosure.

FIG. 19 depicts a diagram illustrating an example enhanced NDP Feedback Report procedure in a non-SST scenario according to the first embodiment of the present disclosure.

FIG. 20 depicts an example enhanced NDP Feedback Report procedure in a SST scenario according to the first embodiment of the present disclosure.

FIG. 21 depicts a flow diagram illustrating a process implemented by an AP in an enhanced NDP Feedback Report procedure according to the first embodiment of the present disclosure.

FIG. 22 depicts a flow diagram illustrating a process implemented by a STA in an enhanced NDP Feedback Report procedure according to the first embodiment of the present disclosure.

FIG. 23 depicts an example format of an EHT NFRP Trigger frame according to a second embodiment of the present disclosure.

FIG. 24 depicts a flow diagram illustrating a process implemented by an AP in an enhanced NDP Feedback Report procedure according to the second embodiment of the present disclosure.

FIG. 25 depicts a flow diagram illustrating a process implemented by a STA in an enhanced NDP Feedback Report procedure according to the second embodiment of the present disclosure.

FIG. 26 depicts an example format of an EHT NFRP Trigger frame according to a third embodiment of the present disclosure.

FIG. 27 depicts a flow diagram illustrating a process implemented by an AP in an enhanced NDP Feedback Report procedure according to the third embodiment of the present disclosure.

FIG. 28 depicts a flow diagram illustrating a process implemented by a STA in an enhanced NDP Feedback Report procedure according to the third embodiment of the present disclosure.

FIG. 29 depicts an example format of an EHT NFRP Trigger frame according to a fourth embodiment of the present disclosure.

FIG. 30 depicts a flow diagram illustrating a process implemented by an AP in an enhanced NDP Feedback Report procedure according to the fourth embodiment of the present disclosure.

FIG. 31 depicts a flow diagram illustrating a process implemented by a STA in an enhanced NDP Feedback Report procedure according to the fourth embodiment of the present disclosure.

FIG. 32 depicts an example format of an EHT NFRP Trigger frame 3200 according to a first example of a fifth embodiment of the present disclosure.

FIG. 33 depicts a flow diagram illustrating a process implemented by an AP in an enhanced NDP Feedback Report procedure according to the first example of the fifth embodiment of the present disclosure.

FIG. 34 depicts a flow diagram 3400 illustrating a process implemented by a STA in an enhanced NDP Feedback Report procedure according to the first example of the fifth embodiment of the present disclosure.

FIG. 35 depicts an example format of an EHT NFRP Trigger frame according to a second example of the fifth embodiment of the present disclosure.

FIG. 36 depicts a flow diagram illustrating a process implemented by an AP in an enhanced NDP Feedback Report procedure according to the second example of the fifth embodiment of the present disclosure.

FIG. 37 depicts a flow diagram illustrating a process implemented by a STA in an enhanced NDP Feedback Report procedure according to the second example of the fifth embodiment of the present disclosure.

FIG. 38 depicts an example format of an EHT NFRP Trigger frame according to a sixth embodiment of the present disclosure.

FIG. 39 depicts a diagram illustrating an example enhanced NDP Feedback Report procedure according to the sixth embodiment of the present disclosure.

FIG. 40 depicts a flow diagram illustrating a process implemented by an AP in an enhanced NDP Feedback Report procedure according to the second example of the sixth embodiment of the present disclosure.

FIG. 41 depicts a flow diagram illustrating a process implemented by a STA in an enhanced NDP Feedback Report procedure according to the sixth embodiment of the present disclosure.

FIG. 42 depicts a flow diagram illustrating a process implemented by an AP in an enhanced NDP Feedback Report procedure according to the second example of the seventh embodiment of the present disclosure.

FIG. 43 depicts a flow diagram illustrating a process implemented by a STA in an enhanced NDP Feedback Report procedure according to the seventh embodiment of the present disclosure.

FIG. 44 depicts an example format of an EHT NFRP Trigger frame according to an embodiment of the present disclosure.

FIG. 45 depicts an example format of an EHT NFRP Trigger frame according to an embodiment of the present disclosure.

FIG. 46 depicts an example format of an EHT NFRP Trigger frame according to another embodiment of the present disclosure.

FIG. 47 depicts a configuration of a communication apparatus, for example an AP, according to various embodiments of the present disclosure.

FIG. 48 depicts a configuration of a communication apparatus, for example a STA, according to various embodiments of the present disclosure.

Skilled artisans will appreciate that elements in the figures are illustrated for simplicity and clarity and have not necessarily been depicted to scale. For example, the dimensions of some of the elements in the illustrations, block diagrams or flowcharts may be exaggerated in respect to other elements to help an accurate understanding of the present embodiments.

### DETAILED DESCRIPTION

Some embodiments of the present disclosure will be described, by way of example only, with reference to the drawings. Like reference numerals and characters in the drawings refer to like elements or equivalents.

In the following paragraphs, certain exemplifying embodiments are explained with reference to an access point (AP) and a station (STA) for a feedback response transmission in an indicated frequency domain.

In the context of IEEE 802.11 (Wi-Fi) technologies, a station, which is interchangeably referred to as a STA, is a communication apparatus that has the capability to use the 802.11 protocol. Based on the IEEE 802.11-2016 definition, a STA can be any device that contains an IEEE 802.11-conformant media access control (MAC) and physical layer (PHY) interface to the wireless medium (WM).

For example, a STA may be a laptop, a desktop personal computer (PC), a personal digital assistant (PDA), an access point or a Wi-Fi phone in a wireless local area network (WLAN) environment. The STA may be fixed or mobile. In the WLAN environment, the terms “STA”, “wireless client”, “user”, “user device”, and “node” are often used interchangeably.

Likewise, an AP, which may be interchangeably referred to as a wireless access point (WAP) in the context of IEEE 802.11 (Wi-Fi) technologies, is a communication apparatus that allows STAs in a WLAN to connect to a wired network. The AP usually connects to a router (via a wired network) as a standalone device, but it can also be integrated with or employed in the router.

As mentioned above, a STA in a WLAN may work as an AP at a different occasion, and vice versa. This is because communication apparatuses in the context of IEEE 802.11 (Wi-Fi) technologies may include both STA hardware components and AP hardware components. In this manner, the communication apparatuses may switch between a STA mode and an AP mode, based on actual WLAN conditions and/or requirements.

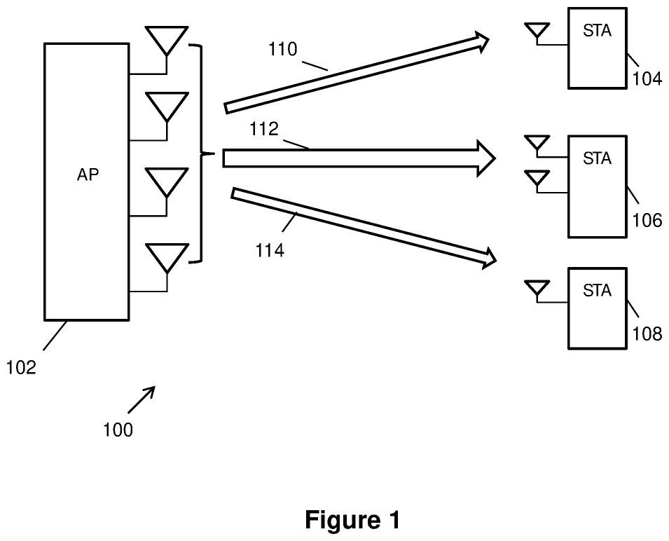

FIG. 1 depicts a schematic diagram 100 of downlink Multi-User (MU) communication between an AP 102 and multiple STAs 104, 106, 108. The downlink communication is an OFDMA (orthogonal frequency division multiple access) communications. For an OFDMA communication in a channel, the AP 102 transmits multiple streams simultaneously to the STAs 104, 106, 108 in the network at different resource units (RUs) within the channel bandwidth. If the RU(s) at which the OFDMA communication occurs occupy whole channel bandwidth, the OFDMA communications is called full bandwidth OFDMA communications. If the RU(s) at which the OFDMA communication occurs occupy a part of channel bandwidth (e.g. one or more 20 MHz subchannel within the channel is punctured), the OFDMA communication is called punctured OFDMA communications. For example, two space-time streams may be directed to the STA 106, another space-time stream may be directed to the STA 104, and yet another space-time stream may be directed to the STA 108. For the sake of simplicity, the two space-time streams directed to the STA 106 are illustrated as a grouped data transmission arrow 112, the space-time stream directed to the STA 104 is illustrated as a data transmission arrow 110, and the space-time stream directed to the STA 108 is illustrated as a data transmission arrow 114.

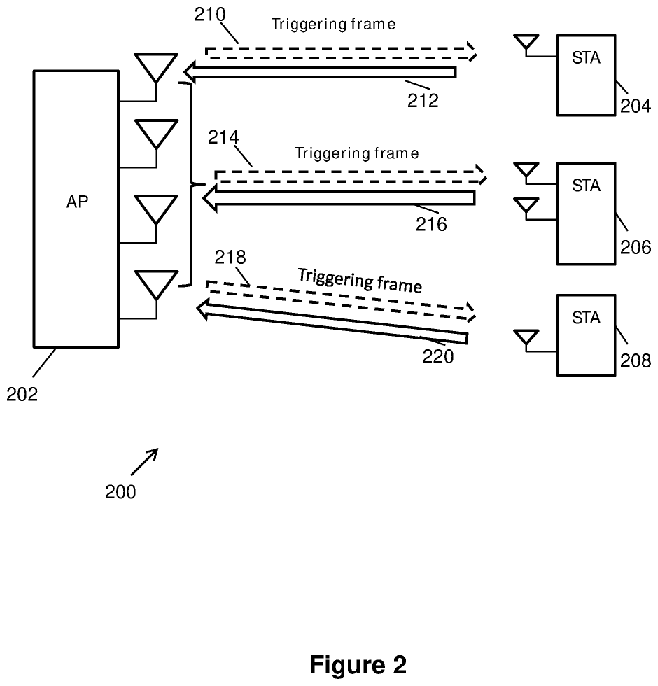

To enable uplink MU transmissions, trigger-based communication is provided to the wireless network. In this regard, FIG. 2 depicts a schematic diagram of trigger-based uplink MU communication 200 between an AP 202 and multiple STAs 204, 206, 208.

Since there are multiple STAs 204, 206, 208 participating in the trigger-based uplink MU communication, the AP 202 needs to coordinate simultaneous transmissions of multiple STAs 204, 206, 208.

To do so, as shown in FIG. 2, the AP 202 transmits triggering frames 210, 214, 218 simultaneously to STAs 204, 206, 208 to indicate user-specific resource allocation information (e.g. the number of space-time streams (STS), a starting STS number and the allocated Rus) each STA can use. In response to the triggering frames, STAs 204, 206, 208 may then transmit their respective space-time streams simultaneously to the AP 202 at different resource units (Rus) within the channel bandwidth according to the user-specific resource allocation information indicated in the triggering frames 210, 214, 218. For example, two space-time streams may be directed to the AP 202 from STA 206, another space-time stream may be directed to the AP 202 from STA 204, and yet another space-time stream may be directed to the AP 202 from STA 208. For the sake of simplicity, the two space-time streams directed to the AP 202 from STA 206 are illustrated as a grouped data transmission arrow 316, the space-time stream directed to the AP 202 from STA 204 is illustrated as a data transmission arrow 212, and the space-time stream directed to the AP 202 from STA 208 is illustrated as a data transmission arrow 220.

Due to packet/PPDU (physical layer protocol data unit) based transmission and distributed MAC (medium access control) scheme in 802.11 WLAN, time scheduling (e.g. TDMA (time division multiple access)-like periodic time slot assignment for data transmission) does not exist in 802.11 WLAN. Frequency and spatial resource scheduling is performed on a packet basis. In other words, resource allocation information is on a PPDU basis. The terms “packet”, “Physical layer (PHY) frame” and “physical layer protocol data unit (PPDU)” are often used interchangeably.

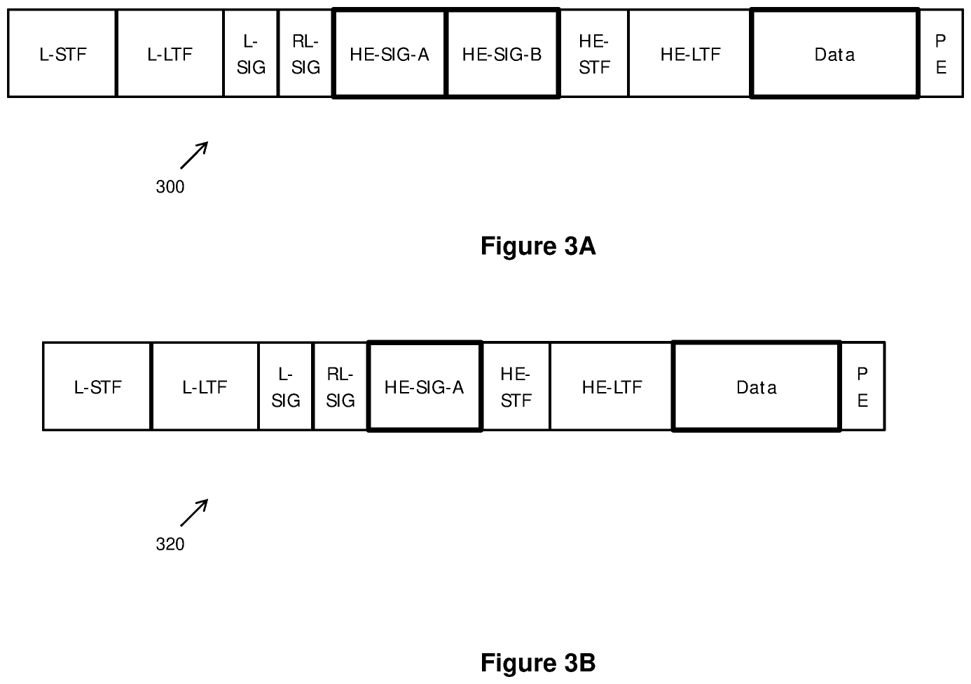

FIG. 3A shows a format of a HE PPDU 300 used for downlink MU communications between an AP and multiple STAs in a HE WLAN, e.g. OFDMA transmission. Such a HE PPDU 300 is referred to as an HE MU PPDU 300. The HE MU PPDU 300 comprises a non-High Throughput (legacy) Short Training Field (L-STF), a legacy Long Training Field (L-LTF), a legacy signal (L-SIG) field, a Repeated L-SIG (R-SIG) field, a HE SIGNAL A (HE-SIG-A) field, a HE Short Training Field (HE-SIG-B) field, a HE Short Training Field (HE-STF), a HE Long Training Field (HE-LTF), a Data field and a Packet Extension (PE) field. In the HE MU PPDU, the HE-SIG-B field provides the OFDMA resource allocation information to allow STAs to look up the corresponding resources to be used in the Data field. The HE-SIG-A field contains the necessary information for decoding the HE-SIG-B field, e.g. MCS for HE-SIG-B, number of HE-SIG-B symbols.

FIG. 3B shows a format of a HE PPDU 320 used for uplink MU communications between an AP and multiple STAs in a HE WLAN. Such a HE PPDU 320 is referred to as an HE TB (trigger-based) PPDU 320. The HE TB PPDU 320 comprises a L-STF, a L-LTF, a L-SIG field, a RL-SIG field, a HE-SIG-A field, a HE-STF, a HE-LTF, a Data field and a PE field. The HE-STF of HE TB PPDU 220 has a duration of 8 μs. The HE TB PPDU is used for uplink MU transmission that is in response to a triggering frame. Instead of using the HE-SIG-B field, the information required for the uplink MU transmission from one or more STAs is carried by the triggering frame that solicits this transmission. In a typical transmission of the HE TB PPDU 320, HE-SIG-A related information is copied from the soliciting triggering frame into the HE-SIG-A field of the HE TB PPDU 320.

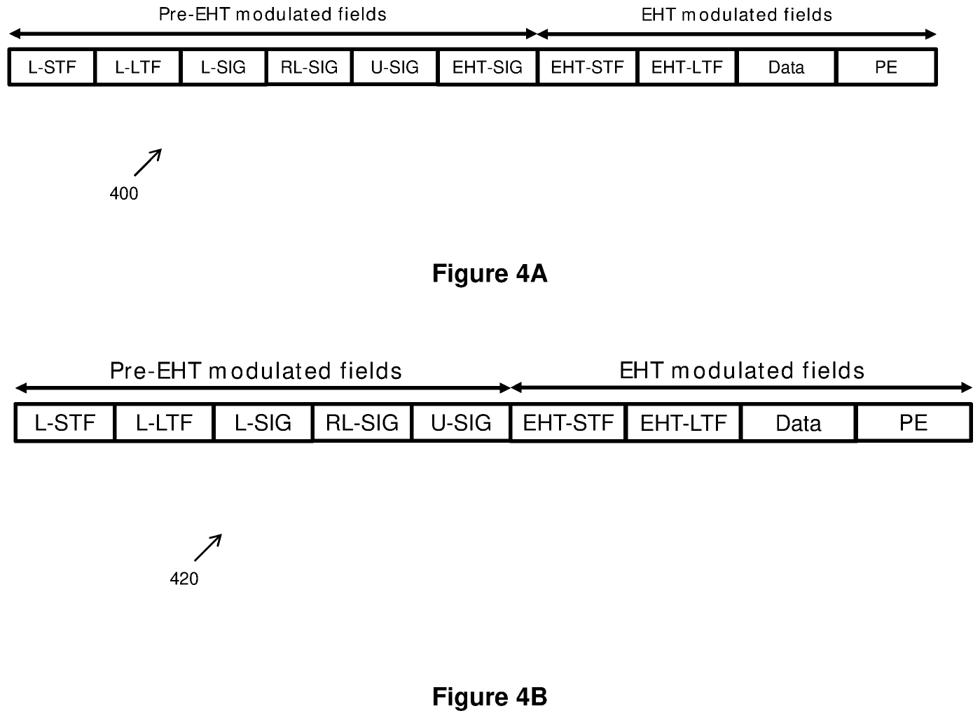

FIG. 4A shows a format of The EHT PPDU 400 used for downlink MU communications between an AP and multiple STAs in an EHT WLAN. Such an EHT PPDU 400 is referred to as an HE MU PPDU 400. The EHT MU PPDU 400 comprises a L-STF, a L-LTF field, a L-SIG field, a RL-SIG field, a universal signal (U-SIG) field, an EHT-SIG field, an EHT-STF, an EHT-LTF, a Data field and a PE field. The L-STF, the L-LTF, the L-SIG field, the RL-SIG field, the U-SIG field and the EHT-SIG field may be grouped as pre-EHT modulated fields, while the EHT-STF, the EHT-LTF, the Data field and the PE field may be grouped as EHT modulated fields.

The U-SIG fields include a part of the version dependent bits for EHT MU PPDU. The U-SIG field has a duration of two OFDM symbols. Data bits in the U-SIG field are jointly encoded and modulated in the same manner as the HE-SIG-A field of 802.11ax. Modulated data bits in the U-SIG field are mapped to 52 data tones of each of the two OFDM symbols in the same manner as the HE-SIG-A field of 802.11ax.

FIG. 4B depicts a format of an EHT PPDU 420 used for uplink MU communications between an AP and multiple STAs in an EHT WLAN. Such an EHT PPDU 420 is referred to as an EHT TB PPDU 420. The EHT TB PPDU 420 comprises a L-STF, a L-LTF, a L-SIG field, a FIF, a U-SIG field, an EHT-STF, an EHT-LTF, a Data field and a PE field. The L-STF, the L-LTF, the L-SIG, the RL-SIG and the U-SIG field may be grouped as pre-EHT modulated fields, while the EHT-STF, the EHT-LTF, the Data field and the PE field may be grouped as EHT modulated fields. An EHT TB PPDU can be used for trigger-based communications that is in response to a soliciting triggering frame.

According to various embodiments, EHT WLAN supports non-trigger-based communications as illustrated in FIG. 1 and trigger-based communications as illustrated in FIG. 2. In non-trigger-based communications, a communication apparatus transmits a PPDU to one other communication apparatus or more than one other communication apparatuses in an unsolicited manner. In trigger-based communications, a communication apparatus transmits a PPDU to one other communication apparatus or more than one other communication apparatuses only after a soliciting triggering frame is received.

As mentioned above, in 802.11ax EHT WLAN, a null data packet (NDP) feedback report procedure is used and allows an High Efficiency (HE) access point (AP) to collect feedback that is not channel sounding (e.g., buffer status, power status) from multiple non-AP HE stations (STAs) to improve 802.11ax efficiency especially in high density environment.

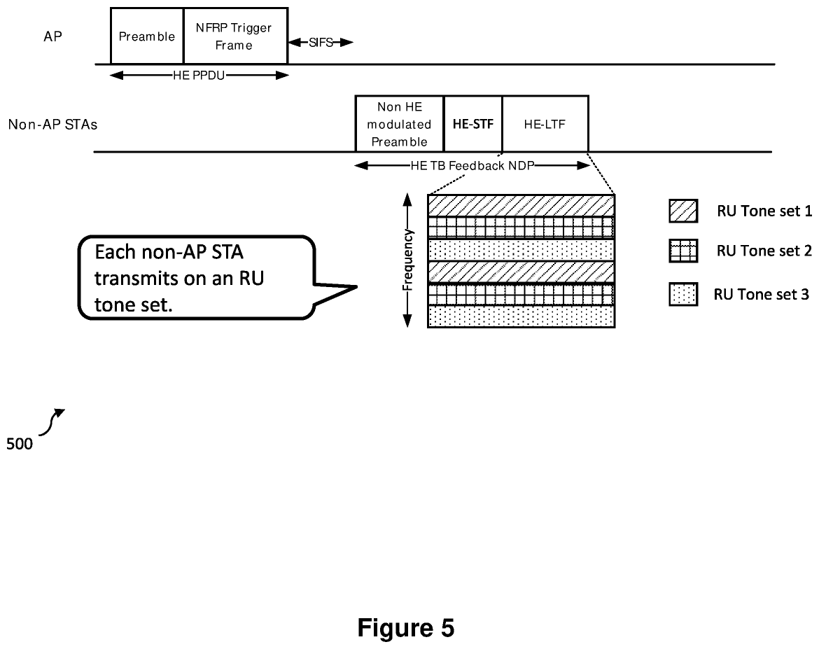

FIG. 5 depicts a diagram 500 illustrating a null data packet (NDP) feedback report procedure. An AP sends a signal comprising a null data packet (NDP) Feedback Report Poll (NFRP) trigger frame to solicit an HE Trigger-based (TB) Feedback NDP from non-AP STAs. The HE TB Feedback NDP may comprise a non-HE modulated preamble, a HE short training field (STF) and a HE long training field (LTF). Each of the non-AP STAs select one of resource unit (RU) tone sets (e.g., RU tone sets 1, 2, 3) in the HE-LTF and transmit its Feedback NDP to feedback its status.

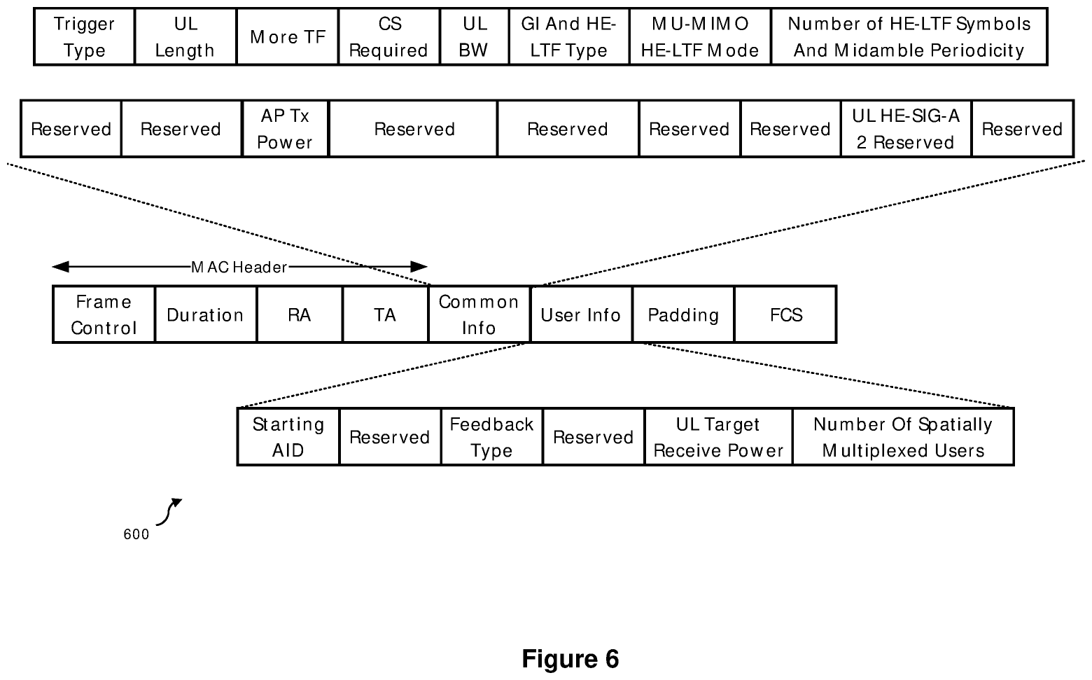

FIG. 6 depicts a format of an HE NFRP Trigger frame 600 in FIG. 5. The HE NFRP Trigger frame 600 consists of a Frame Control field, a Duration field, a Recipient Address (RA) field, a Transmitter Address (TA) field, a Common Info field, a User Info field, a Padding field and a FCS (frame check sequence) field. The Frame Control field, the Duration field, the RA field and the TA field may be grouped as MAC header. The Common field consists of a Trigger Type subfield, a Uplink (UL) Length subfield, a More TF subfield, a CS Required subfield, a UL Bandwidth (BW) subfield, a Guard Interval (GI) And HE-LTF Type subfield, a MU-MIMO HE-LTF Mode subfield, a Number of HE-LTF Symbols And Midamble Periodicity subfield, an AP Transmission (Tx) Power subfield and an UL HE-SIG-A 2 Reserved subfield. The User Info field comprises a Starting Association Identifier (AID) subfield, a Feedback Type subfield, a UL Target Receive Power subfield and a Number Of Spatially Multiplexed Users subfield.

If a non-AP STA receives an NFRP Trigger frame and determines that it satisfies the feedback condition, it will prepare a TB Feedback NDP comprising an NDP feedback report response. One example feedback condition is that the non-AP STA's AID is greater than or equal to the starting AID and less than starting AID+N_{STA} where N_{STA} is calculated using equation (1).

$${N}_{STA} = 18 \times {2}^{BW} \times \qquad Equation ( 1 )$$

$$( value of the Number of Spatially Multiplexed Users subfield + 1 )$$

The RU tone set where the non-AP STA will transmit its Feedback NDP on is determined based on equation (2), where AID is the AID of the non-AP STA, the starting AID is the value indicated in the Starting AID field of the User Info field in NFRP Trigger frame, and the BW is the value indicated in the UL BW subfield of the Common Info field in NFRP Trigger frame (starting from 0).

$$RU\_TONE \_SET \_INDEX = 1 + ( ( AID - Starting AID ) mod ( 18 \times {2}^{BW} ) ) \qquad Equation ( 2 )$$

Once the non-AP STA(s) transmits its Feedback NDP and the AP receives it, the AP can derive the list of AIDs from the resources to which an NDP feedback report response was sent and their responses.

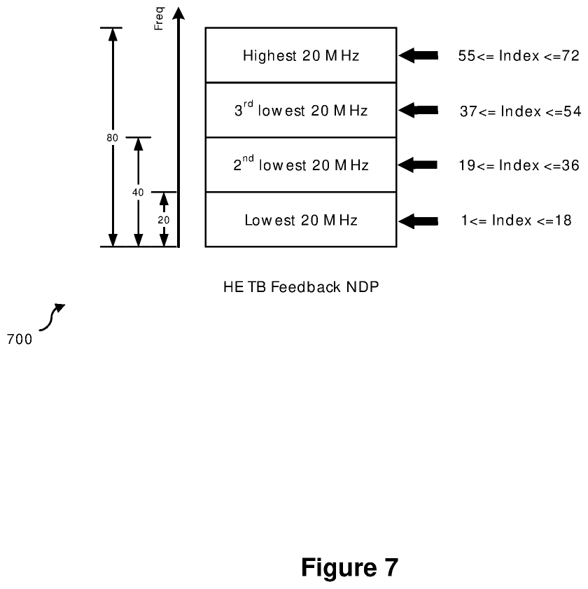

Table 9 annexed to the description, summarizes the RU tone indices and their corresponding RU tone sets. From Table 9, it is shown that the RU tone set with index starting from 1 will be mapped into selected LTF symbol(s) of TB Feedback NDP starting from the lowest 20 MHz. FIG. 7 depicts a diagram 700 illustrating a mapping of RU tone sets from different RU tone set indices to a LTF symbol(s) of the TB Feedback NDP. A RU Tone set index (RU_TONE_SET_INDEX) from 1 to 18 will be mapped/correspond to a RU tone set in the lowest 20 MHz frequency domain; a RU Tone set index from 19 to 36 will be mapped/correspond to a RU tone set in the second lowest 20 MHz frequency domain; a RU Tone set index from 37 to 54 will be mapped/correspond to a RU tone set in the third lowest 20 MHz frequency domain; and a RU tone set index from 55 to 72 will be mapped/correspond to a RU tone set in the highest 20 MHz frequency domain.

With conventional NDP Feedback report procedures, there are some scenarios where some non-AP STAs may not be able to participate in the feedback.

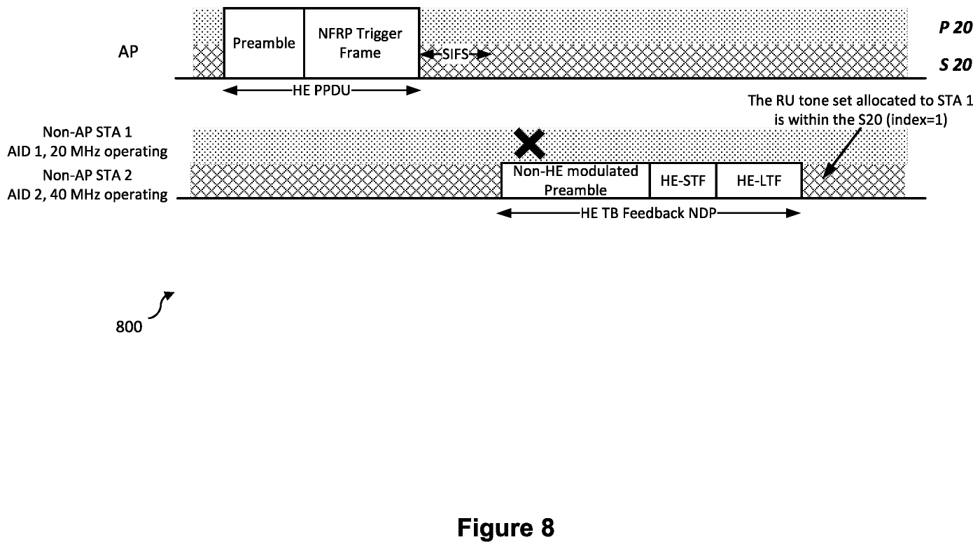

FIG. 8 depicts a diagram illustrating an example NDP Feedback report procedure in a 40 MHz channel in a non-SST scenario. All non-AP STAs park on the primary 20 MHz frequency segment/domain (or primary channel or P20) and listen to the primary channel. In this example, the primary 20 MHz channel (P20) is at the higher 20 MHz frequency segment; the secondary 20 MHz channel (S20) is at the lower 20 MHz frequency segment; non-AP STA1 is operating in the primary 20 MHz channel while non-AP STA2 is operating in the 40 MHz channel (P20+secondary 20 MHz channel (S20)). An AP sends a NFRP Trigger frame to solicit a feedback response from non-AP STA1 and non-AP STA2. However, if the bandwidth of the TB Feedback NDP is not proper (e.g., the RU tone set allocated to non-AP STA1 is within S20 (index=1), the non-AP STA1 which is operating in the primary channel will not be able to participate in the feedback.

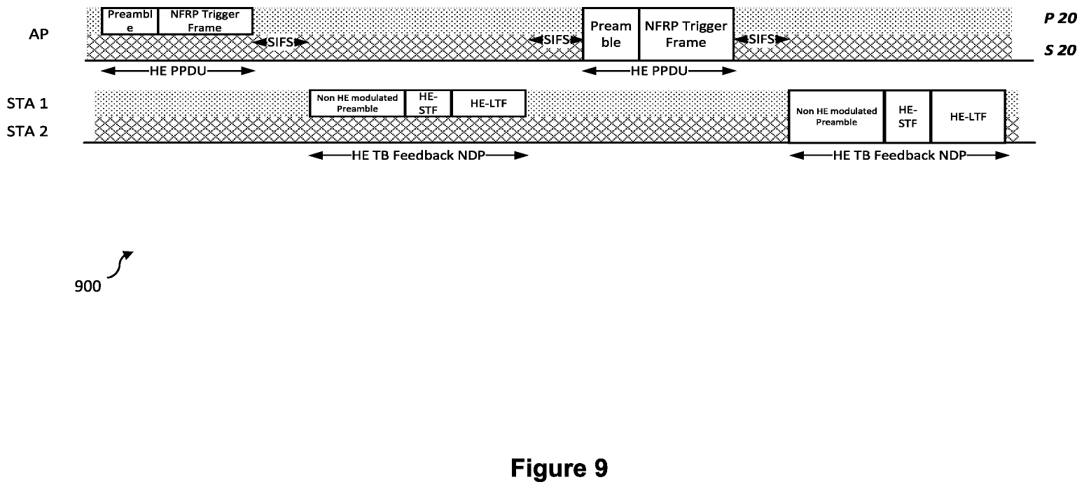

To resolve the issue, where one or more assigned RU tone sets are out of one or more non-AP STA's operating channel, in this case the RU tone set that is allocated to non-AP STA1 is within S20 and outside its P20 operating channel, more than one round of NDP Feedback procedure is required. FIG. 9 depicts a diagram 900 illustrating more than one round of NDP Feedback report procedure in a 40 MHz channel in a non-SST scenario. Similar to the example illustrated in FIG. 8, all non-AP STAs park on the primary 20 MHz frequency segment/domain (or primary channel or P20) and listen to the primary channel; the primary 20 MHZ channel (P20) is at the higher 20 MHz frequency segment; the secondary 20 MHZ channel (S20) is at the lower 20 MHz frequency segment; non-AP STA1 is operating in the primary 20 MHz channel while non-AP STA2 is operating in the 40 MHz channel (P20+secondary 20 MHz channel (S20)). An AP first sends a 20 MHz NFRP Trigger frame in the P20 to solicit a feedback from non-AP STA1 with an operating channel in P20. The non-AP STA1 then transmits a 20 MHz HE TB Feedback NDP comprising its feedback response in P20. Subsequently, the AP sends a 40 MHz NFRP Trigger frame in the 40 MHz channel (P20 and S20), and then STA2 and other STAs with the same operating channel will then transmit a 40 MHz HE TB Feedback NDP comprising their respective feedback responses in the 40 MHz channel. Such multiple rounds of NDP Feedback procedures will bring latency to dense environment. Therefore, a method to keep the NDP Feedback procedure in a single round is needed.

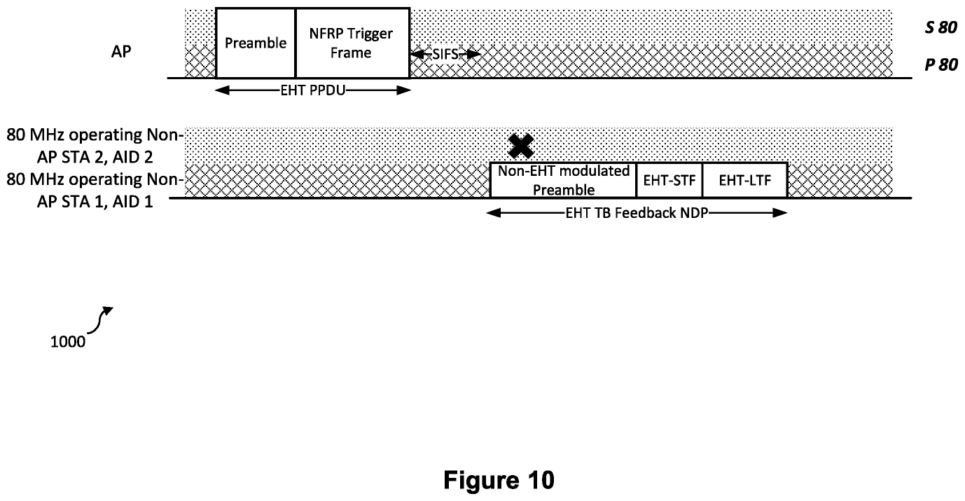

FIG. 10 depicts a diagram 1000 illustrating an example NDP Feedback report procedure in a 40 MHz channel in a SST scenario. In this example, the primary 80 MHz channel (P80) is at the lower 80 MHz frequency segment; the secondary 80 MHz channel (S80) is at the higher 80 MHz frequency segment; non-AP STA1 is operating in the primary 80 MHz channel while non-AP STA2 is operating in the secondary 80 MHz channel (S80). According to 802.11 specification, a 20 MHZ operating non-AP STA can participate transmission/reception with larger bandwidth in a secondary 20 MHz channel. Noting that, in 802.11be or future amendment, 80/160 MHz operating non-AP STAs such as non-AP STA2 parking on the secondary 80/160 MHz channel will be supported, the assigned RU tone sets of such 80/160 MHz operating non-AP STAs parking on the secondary 80/160 MHz channel is likely to fall on subchannels that are out of their operating frequency range/domain. As a result, according to SST operation limitation, the AP will not initiate the NDP feedback report procedure for those non-AP STAs.

Referring to FIG. 10, an AP transmits a NFRP Trigger frame to solicit feedback from non-AP STA1 and STA2. The RU tone set for non-AP STA1 is allocated within its operating channel at P80, therefore non-AP STA1 can transmit its feedback response back to the AP. However, based on the AID2 and UL BW 160 MHz, the RU tone set for non-AP STA2 is allocated within the P80 and therefore non-AP STA2 is unable to generate a feedback response. The AP can predict such a case, therefore will not initiate the NDP Feedback Report for STA2.

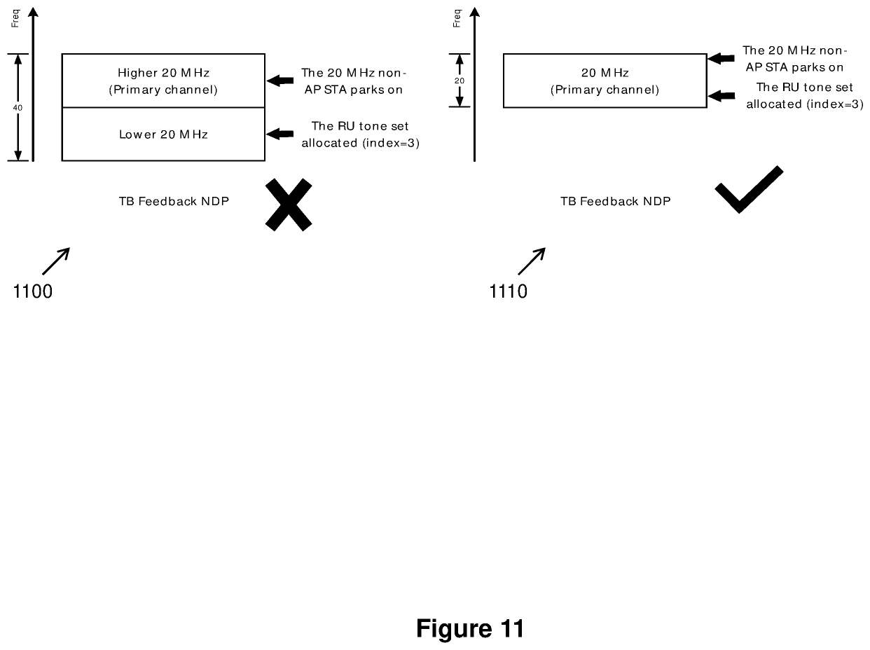

Conventionally, for the issue in non-SST scenarios, the AP may select proper parameters, e.g., 20 MHZ TB Feedback NDP, to make sure the allocated RU tone is within the operating channel of non-AP STAs. FIG. 11 depicts a 40 MHz TB Feedback NDP 1100 and a 20 MHz TB Feedback NDP 1110 for transmitting a feedback response in a non-SST scenario. In this case, the non-AP STA parks on the higher 20 MHZ (primary channel) while the RU tone set allocated to the non-AP STA is at the lower 20 MHz frequency segment (RU tone set index value=3). If the AP indicates that a feedback response is to be sent in a 40 MHz TB Feedback NDP 1100, as the allocated RU tone set does not correspond to the non-AP STA's operating channel at the higher 20 MHz channel, the non-AP STA is unable to transmits its feedback response; whereas if the AP indicates that a feedback response is to be sent in a 20 MHz TB Feedback NDP 1110, the frequency domain corresponding to the RU tone set assigned to the non-AP STA will fall within the operating channel of the non-AP STA and therefore the non-AP STA will be able to transmit its feedback response.

However, it is noted that in 802.11ax, even the supported number of STAs in a 20 MHZ (up to 36) may be enough, but in 11be or future amendments, a support for higher density environment will be required and therefore the convention way to make sure the allocated RU tone is within the operating subchannels of non-AP STAs by selecting proper parameters, e.g., a 20 MHz TB Feedback NDP, as described in FIG. 11, may not be applicable. In this case, if the number of STAs in the basic service set (BSS) is larger than the proper bandwidth selected by the AP, more than one round of NDP Feedback Report is still needed.

According to the present disclosure, an enhanced NDP Feedback Report procedure is performed to address the issues. More particularly, the AP sends a Downlink (DL) physical layer protocol data unit (PPDU) carrying one or more extremely high throughput (EHT) null data packet (NDP) feedback report poll (NFRP) Trigger frame to solicit EHT TB Feedback NDP from associated non-AP STAs. The EHT NFRP Trigger frame(s) contains a frequency domain indication/information indicating the non-AP STAs to transmit on assigned RU tone sets within their own operating channels. The indication/information may include a new parameter used during the RU tone set calculation phase and new frequency information indicating a frequency domain within their own operating channels used for transmitting their feedback response. After a short interframe spacing (SIFS), non-AP STAs which satisfy feedback conditions will simultaneously send their EHT TB Feedback NDPs with their feedback responses to the associated AP. It is noted that when the number of associated non-AP STAs is not larger than the number of non-AP STAs supported by a TB Feedback NDP with the basic service set (BSS) bandwidth, such enhanced NDP feedback report can be finished in a single round thus reduce the latency in dense environment.

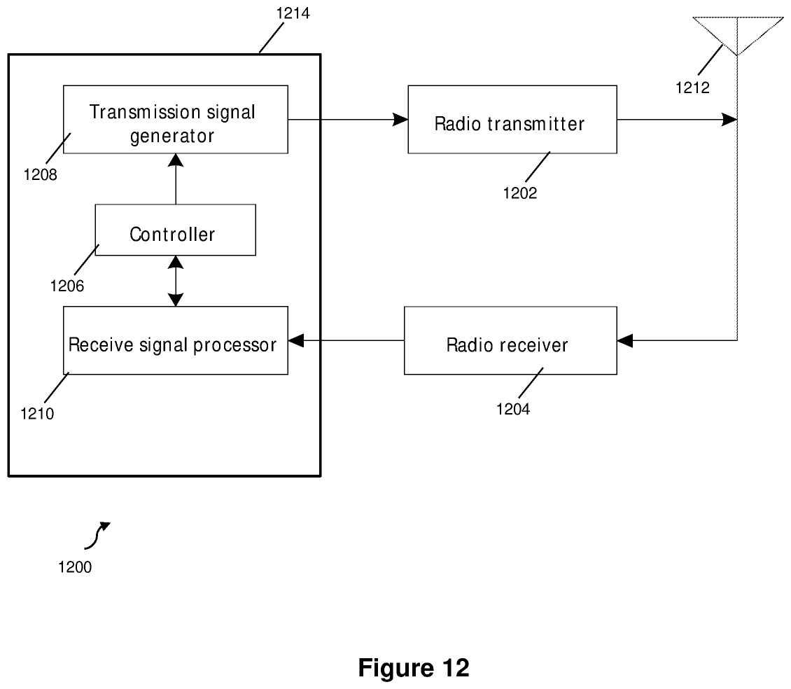

FIG. 12 depicts a schematic, partially sectioned view of a communication apparatus 1200 according to the present disclosure. The communication apparatus 1200 may also be implemented as an AP or a STA.

As shown in FIG. 12, the communication apparatus 1200 may include circuitry 1214, at least one radio transmitter 1202, at least one radio receiver 1204, and at least one antenna 1212 (for the sake of simplicity, only one antenna is depicted in FIG. 12 for illustration purposes). The circuitry 1214 may include at least one controller 1206 for use in software and hardware aided execution of tasks that the at least one controller 1206 is designed to perform, including control of communications with one or more other communication apparatuses in a wireless network. The circuitry 1214 may furthermore include at least one transmission signal generator 1208 and at least one receive signal processor 1210. The at least one controller 1206 may control the at least one transmission signal generator 1208 for generating MAC frames (for example NFRP Trigger frame) and PPDUs (for example PPDUs used for non-trigger-based communications or PPDUs used for trigger-based sounding procedure, or PPDUs used for trigger-based downlink transmissions if the communication apparatus 1200 is an AP, and for example or PPDUs used for trigger-based uplink transmissions if the communication apparatus 1200 is a STA) to be sent through the at least one radio transmitter 1202 to one or more other communication apparatuses and the at least one receive signal processor 1210 for processing MAC frames (for example NFRP Trigger frame) and PPDUs (for example PPDUs used for non-trigger-based communications or PPDUs used for trigger-based sounding procedure, or PPDUs used for trigger-based uplink transmissions if the communication apparatus 1200 is an AP, and for example or PPDUs used for trigger-based downlink transmissions if the communication apparatus 1200 is a STA) received through the at least one radio receiver 1204 from the one or more other communication apparatuses under the control of the at least one controller 1206. The at least one transmission signal generator 1208 and the at least one receive signal processor 1210 may be standalone modules of the communication apparatus 1200 that communicate with the at least one controller 1206 for the above-mentioned functions, as shown in FIG. 12. Alternatively, the at least one transmission signal generator 1208 and the at least one receive signal processor 1210 may be included in the at least one controller 1206. It is appreciable to those skilled in the art that the arrangement of these functional modules is flexible and may vary depending on the practical needs and/or requirements. The data processing, storage and other relevant control apparatus can be provided on an appropriate circuit board and/or in chipsets. In various embodiments, when in operation, the at least one radio transmitter 1202, at least one radio receiver 1204, and at least one antenna 1212 may be controlled by the at least one controller 1206.

The communication apparatus 1200, when in operation, provides functions required for feedback response transmission in indicated frequency domain. For example, the communication apparatus 1200 may be an AP, and the circuitry 1214 (for example the at least one transmission signal generator 1208 of the circuitry 1214) may, in operation, generate a signal that solicits a feedback response, where the signal comprises frequency domain information indicating a frequency domain used for transmitting the feedback response within an operating channel of one or more other communication apparatuses. The radio transmitter 1202 may in operation, transmits the signal to one or more other communication apparatuses.

The communication apparatus 1200 may be a STA, and the at least one radio receiver 1204 may, in operation, receive a signal soliciting a feedback response, where the signal comprises frequency domain information indicating a frequency domain used for transmitting the feedback response within its operating channel. The circuitry 1214 (for example the at least one receive signal processor 1210 of the circuitry 1214) may, in operation, process the signal and generate the feedback response, and the radio transmitter 1202 may in operation, transmits the feedback response in the frequency domain.

In an embodiment, the frequency domain information comprises an adjustment of a resource unit (RU) tone set assigned to the communication apparatus 1200 to correspond to the frequency domain, and the feedback response comprises a trigger-based (TB) feedback null data packet (NDP) and the circuitry 1214 (for example the at least one transmission signal generator 1208 of the circuitry 1214) generate a TB feedback NDP carrying the feedback response.

Additionally, the frequency domain information is a parameter and the circuitry 1214 (for example the at least one receive signal processor 1210 of the circuitry 1214) is configured to calculate the adjustment of the assigned RU tone set in a calculation phase.

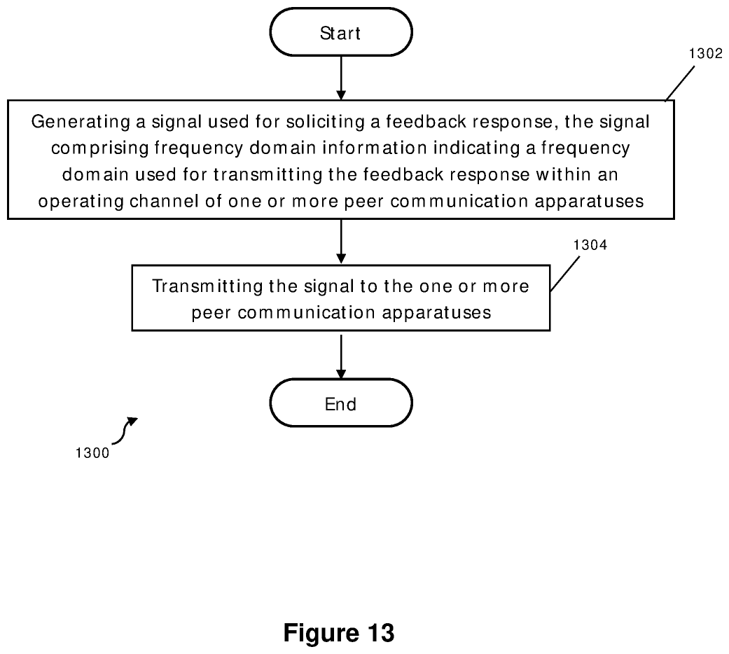

FIG. 13 shows a flow diagram 1300 illustrating a communication method implemented by a base communication apparatus such as AP according to various embodiments of the present disclosure. In step 1302, a step of generating a signal used for soliciting a feedback response is carried out, the signal comprising frequency domain information indicating a frequency domain used for transmitting the feedback response within an operating channel of one or more peer communication apparatuses such as STAs. In step 1304, a step of transmitting the signal to the one or more peer communication apparatuses.

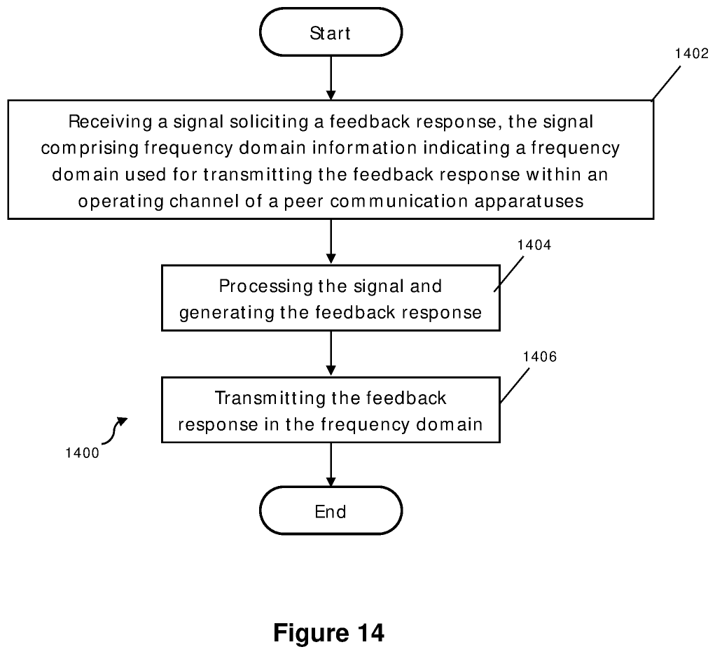

FIG. 14 shows a flow diagram 1400 illustrating a communication method implemented by a peer communication apparatus such as STA according to various embodiments of the present disclosure. In step 1402, a step of receiving a signal soliciting a feedback response is carried out, the signal comprising frequency domain information indicating a frequency domain used for transmitting the feedback response within an operating channel of the peer communication apparatus. In step 1404, a step of processing the signal and generating the feedback response is carried out. In step 1406, a step of transmitting the feedback response in the frequency domain is carried out.

In one embodiment of the present disclosure, in order to support more non-AP STAs in an EHT TB Feedback NDP with same bandwidth as HE TB Feedback NDP, more EHT-LTF symbols (e.g., 4 or 6) can be contained. In this way, 2 or 3 times of number of non-AP STAs can be supported compared with HE TB Feedback NDP with same bandwidth.

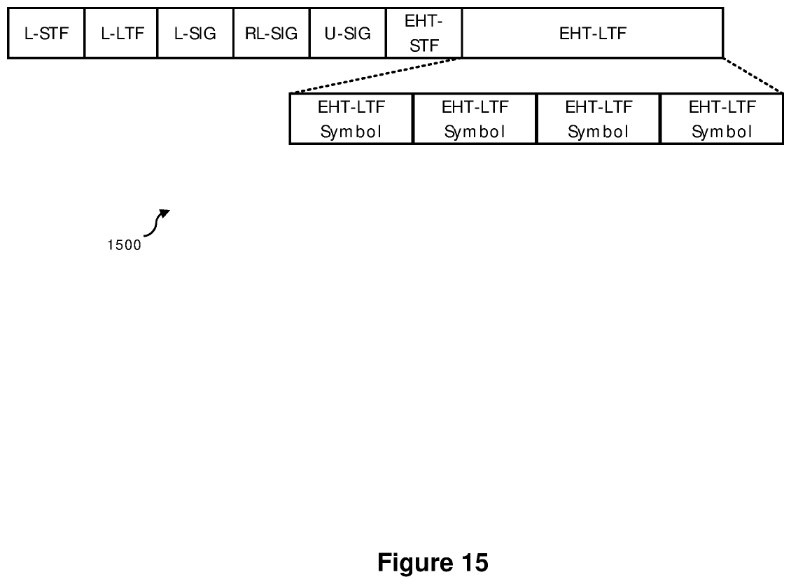

FIG. 15 depicts an example format of EHT TB Feedback NDP 1500 according to an embodiment of the present disclosure. The EHT TB Feedback NDP 1500 comprises a L-STF, a L-LTF, an L-SIG field, a RL-SIG field, a U-SIG field an EHT-STF and an EHT-LTF. The EHT-LTF in this embodiment contains 4 EHT-LTF symbols, allowing 2 times of number of non-AP STAs be supported.

The number of EHT-LTF symbols contained in the EHT-LTF can be indicated in the Number of HE/EHT-LTF Symbols subfield in a Common Info field. Therefore, the number of STAs that are multiplexed on the same set of tones in the same RU is increased. Correspondingly, the Number Of Spatially Multiplexed Users subfield, which indicates the number of STAs that are multiplexed on the same set of tones in the same RU and is encoded as the number of STAs minus 1, should include more bits. The position of the Number Of Spatially Multiplexed Users subfield may be shifted to the reserved subfield to have more bits used.

For each non-AP STA, the number of EHT-LTF symbols it can transmit on can be calculated using equation (3).

$${N}_{LTFperSTA} = \frac{\begin{matrix}value of Number Of \\ HE / EHT - LTF Symbols subfield\end{matrix}}{\begin{matrix}value of Number of Spatially \\ Multiplexed Users subfield\end{matrix}} \qquad Equation ( 3 )$$

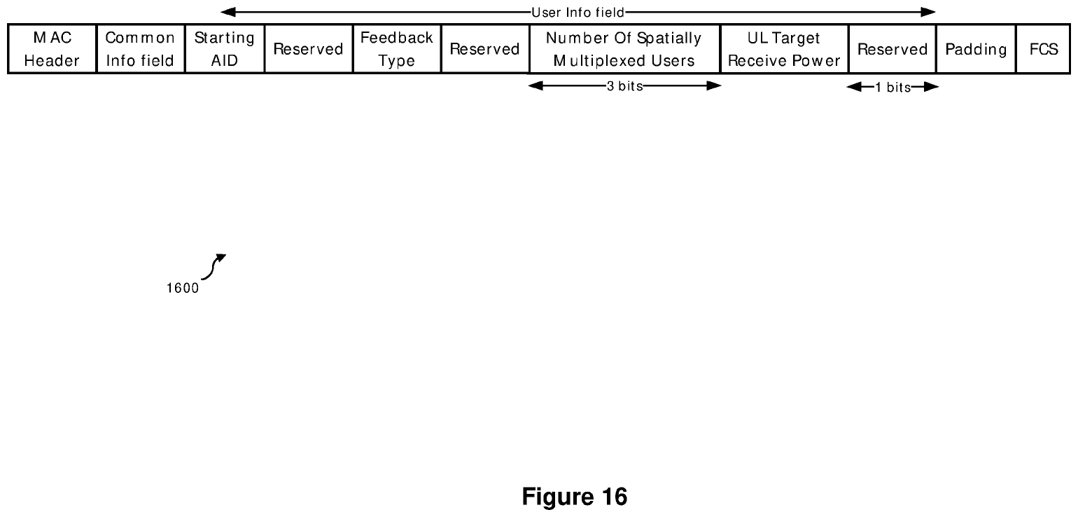

FIG. 16 depicts an example format of an EHT NFRP Trigger frame 1600 according to another embodiment of the present disclosure. The EHT NFRP Trigger frame 1600 comprises a MAC Header (Frame Control field, Duration field, RA field and TA field), a Common Info field, a Starting AID field, a Feedback Type field, a Number Of Spatially Multiplexed Users field, a UL Target Receive Power field, a Padding field and a FCS field. The non-AP STA's AID is greater than or equal to the starting AID and less than starting AID+N_{STA} where N_{STA} IS calculated using equation (1). The assignment of the spatial stream (i.e., EHT-LTF symbol) is similar to that of 802.11ax, according to equation (4). The non-AP STA will transmit on STARTING_STS_NUM^{th}˜(STARTING_STS_NUM^{th}+N_{LTFperSTA}−1)^{th} EHT-LTF symbols.

$$STARTING\_STS \_NUM = ( AID - STARTING AID ) / 18 \times {2}^{BW} \qquad Equation ( 4 )$$

With more EHT-LTF symbols, 20 MHZ EHT TB Feedback NDP can support more non-AP STAs. For example, in SST scenarios, with a 20 MHz EHT TB Feedback NDP in the primary channel, 72 (4 EHT-LTF symbols) or 144 (6 EHT-LTF symbols) non-AP STAs can be supported. This is enough for some high-density cases, for example, when the number of associated STAs is smaller than 72 or 144 respectively. This feedback response procedure using an EHT TB Feedback NDP with more EHT-LTF symbols provide a simple solution in a high density environment, for example, cases with multiple APs,

However, such feedback response procedure has limited applicable cases. For example, in a higher density environment, for example, Internet-of-Things (IOT) application in which an AP may support thousands of STAs, or in SST scenario, such feedback response procedure cannot solve the issues of some STAs not able to participate in feedback response.

In the following paragraphs, a first embodiment of the present disclosure where a parameter comprising an RU tone sex index offset value is used as frequency domain information to indicate a frequency domain within a STA's operating channel to transmit its feedback response is described.

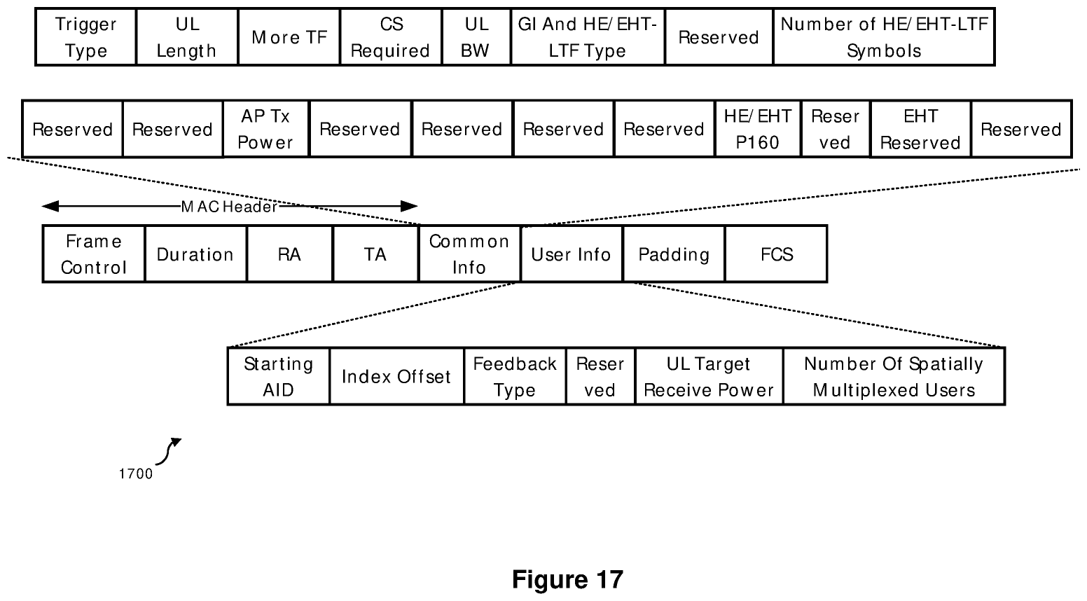

FIG. 17 depicts an example format of an EHT NFRP Trigger frame 1700 according to the first embodiment of the present disclosure. The EHT NFRP Trigger frame 1700 comprises a Frame Control field, a Duration field, a RA field, a TA field, a Common Info field, a User Info field, a Padding field and a FCS field. The Frame Control field, the Duration field, the RA field and the TA field may be grouped as MAC header. The Common field consists of a Trigger Type subfield, a Uplink (UL) Length subfield, a More TF subfield, a CS Required subfield, a UL Bandwidth (BW) subfield, a Guard Interval (GI) And HE-LTF Type subfield, a Number OF HE/EHT-LTF Symbols subfield, an AP Transmission (Tx) Power subfield, a HE/EHT P160 subfield and an EHT Reserved subfield. The User Info field comprises a Starting AID subfield, an Index Offset field, a Feedback Type subfield, a UL Target Receive Power subfield and a Number Of Spatially Multiplexed Users subfield.

The EHT format is indicated in the Common Info field. The Index Offset subfield carries 8 bits and indicates an RU tone set index offset value between 0 to 144. The maximal value is decided based on the maximal number of non-AP STAs can be supported. For example, the value of 144 is decided based on the maximal number of non-AP STAs can be supported by an 80 MHz EHT TB Feedback NDP.

Upon receipt of the EHT NFRP Trigger frame 1700, associated non-AP STAs that satisfy feedback conditions will calculate its RU tone set index based on values of AID, Starting AID, UL BW and Index Offset subfields, and determine its RU tone set to transmit using equation (5).

$$RU\_TONE \_SET \_INDEX = 1 + ( ( AID - Starting AID ) mod ( 18 \times {2}^{BW} ) ) + Index Offset \qquad Equation ( 5 )$$

With the value of Index Offset added to the equation, the index of assigned RU tone set to a non-AP STA can be controlled and set to a higher value, falling on a certain 20 MHz subchannel in a higher frequency domain, e.g., within the operating channel o the non-AP STA. Similarly, the index of assigned RU tone set can also be controlled and set to a lower value by adjusting the value of Starting AID.

It is noted that the AP shall determine such Index Offset carefully to avoid assignment of a same RU tone set index to more than one non-AP STAs.

In an embodiment, the AP may transmit more than one EHT NFRP Trigger frames to different non-AP STAs in PPDU using multiple-user (MU) transmission (MU-MIMO and/or OFDMA) or in an aggregate physical layer protocol data unit (A-PPDU). Each EHT NFRP Trigger may comprise different Starting AID value and Index Offset value.

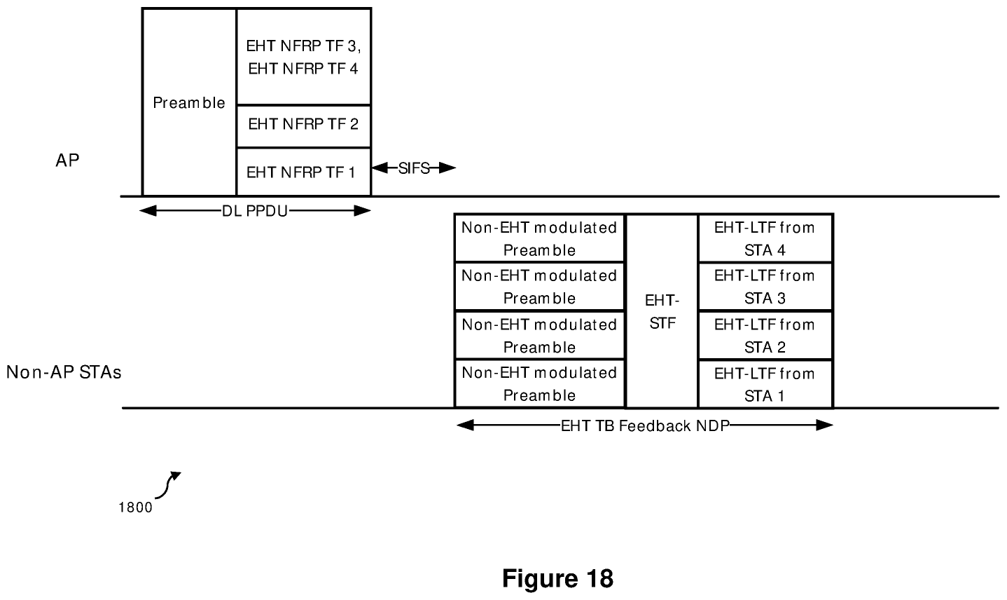

FIG. 18 depicts a diagram 1800 illustrating an example NDP Feedback report procedure according to the first embodiment of the present disclosure. An AP transmits a DL PPDU comprising two EHT NFRP Trigger Frames (TFs) (e.g., EHT NFRP TF 1 and 2) using OFDMA communication to STA1 and STA2 and another two EHT NFRP TF (e.g., EHT NFRP TF 3 and 4) using MU-MIMO communication to STA3 and STA4, respectively. Each of the EHT NFRP TFs may comprise different Starting AID value and Index Offset value. STA1, STA2, STA3, STA4 receive the DL PPDU and then calculate their respective adjusted/offset RU tone set index and determine corresponding RU tone sets and frequency domains to transmit their feedback responses. In this case, the adjusted/offset RU tone set indices of STA1, STA2, STA3, STA4 map to EHT-LTF symbols of TB Feedback NDP at the lowest frequency domain, the second lowest frequency domain, the third lower frequency domain and the highest frequency domain, respectively. Subsequently, STA1, STA2, STA3, STA4 then transmits its TB Feedback NDP with a feedback response in their respective frequency domains.

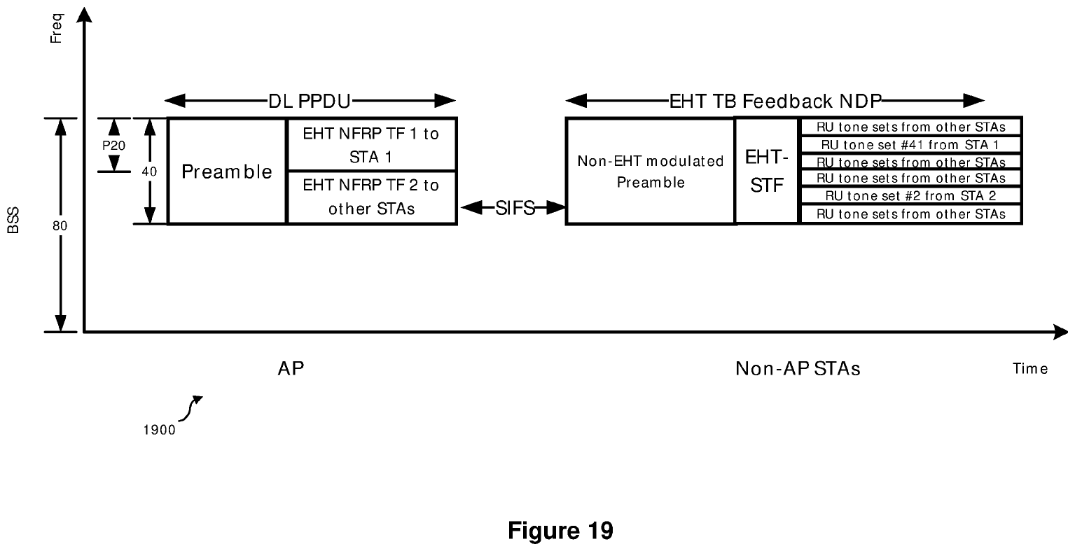

FIG. 19 depicts a diagram 1900 illustrating an example enhanced NDP Feedback Report procedure in a non-SST scenario according to the first embodiment of the present disclosure. There is an 80 MHz BSS, inside which, the primary channel is the highest 20 MHz. (P20) Out of a total of 40 non-AP STAs associated with an AP within the BSS, there is a 20 MHz operating STA (STA1 with AID 1) parking on the P20 and a 80 MHz operating STA (STA2 with AID 2) on the 80 MHz channel.

The AP sends a DL PPDU carrying two EHT NFRP Trigger frames by OFDMA transmission, soliciting a 40 MHz EHT TB Feedback NDP. In the EHT NFRP Trigger frame sent to STA1, the Starting AID subfield is set to 1 and the Index Offset subfield is set to 40; whereas in the EHT NFRP Trigger frame sent to STA2 and other STAs, the Starting AID subfield is set to 1 and the Index Offset subfield is set to 0.

Upon receipt of the EHT NFRP Trigger frame, STA1 transmits on RU tone set with index #41 of the EHT TB Feedback NDP while STA2 transmits on RU tone set with index #2 of the EHT TB Feedback NDP. As a result, all non-AP STAs can be supported in a single round of the enhanced NDP Feedback Report procedure.

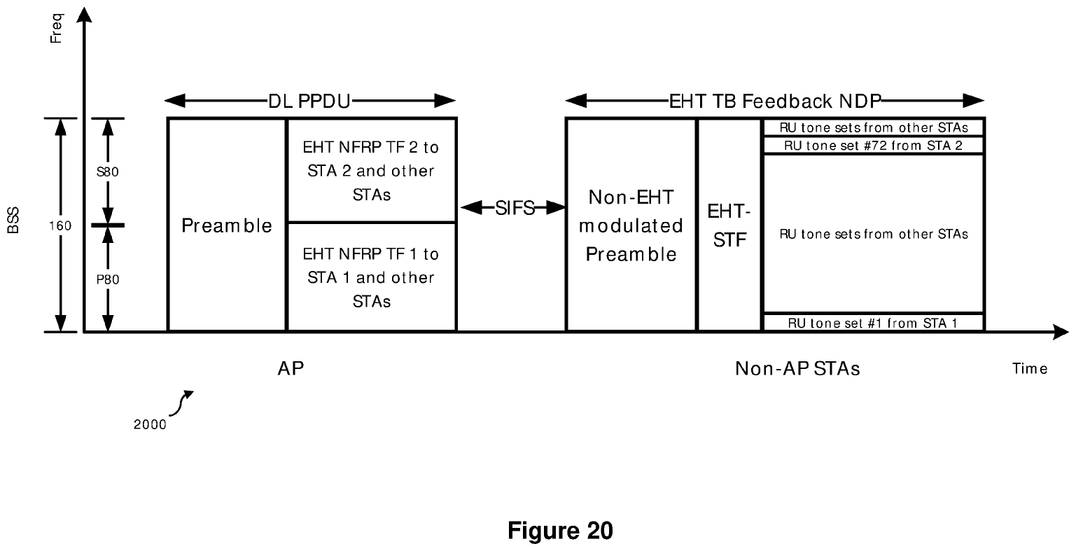

FIG. 20 depicts a diagram 2000 illustrating an example enhanced NDP Feedback Report procedure in a SST scenario according to the first embodiment of the present disclosure. There is a 160 MHz BSS, inside which, the primary channel is the lowest 80 MHz (P80). Out of a total of 40 non-AP STAs associated with an AP within the BSS, there is an 80 MHz operating STA (STA1 with AID 1) parking on the P80 and another 80 MHz operating STA (STA2 with AID 2) parking on the secondary 80 MHz.

The AP sends two EHT NFRP Trigger frames soliciting a 160 MHz EHT TB Feedback NDP. In the EHT NFRP Trigger frame sent to STA1 and some other STAs, the Starting AID subfield is set to 1 and the Index Offset subfield is set to 0; whereas in the EHT NFRP Trigger frame sent to STA2 and some other STAs, the Starting AID subfield is set to 1 and the Index Offset subfield is set to 72.

Upon receipt of the EHT NFRP Trigger frame, STA1 transmits on RU tone set with index #1 of the EHT TB Feedback NDP while STA2 transmits on RU tone set with index #72 pf the EHT Feedback NDP. As a result, all non-AP STAs parking on different subchannels can be supported in a single round of the enhanced NDP Feedback Report procedure.

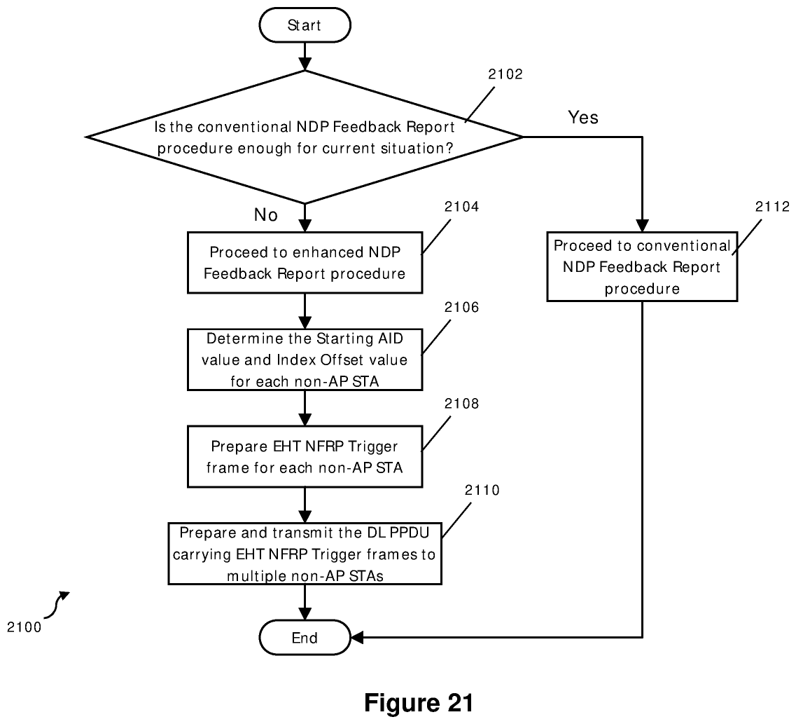

FIG. 21 depicts a flow diagram 2100 illustrating a process implemented by an AP in an enhanced NDP Feedback Report procedure according to the first embodiment of the present disclosure. The process starts with step 2102. In step 2102, a step of determining if the conventional NDP Feedback Report procedure is enough for the current situation. In an embodiment, in step 2102, the step of determining if the conventional NDP Feedback Report procedure is enough comprises a step of determining if all non-AP STAs can be supported in a single round of NDP Feedback Report procedure in either non-SST or SST scenario.

If it is determined that the convention NDP Feedback Report procedure is not enough, step 2104 is carried out; otherwise step 2112 is carried out. In step 2104, the process proceeds to an enhanced NDP Feedback Report procedure. In step 2106, a step of determining the Starting AID value and Index Offset value for each non-AP STA is carried out. In step 2108, a step of preparing and generating EHT NFRP Trigger frame for each non-AP STA is carried out. In step 2110, a step of preparing and transmitting a DL PPDU carrying the EHT NFRP Trigger frames to multiple non-AP STAs is carried out, and the process may end. Returning to step 2102, if it is determined that the convention NDP Feedback Report procedure is enough for the current situation, the conventional NDP Feedback Report procedure proceeds in step 2112 and the process may end after that.

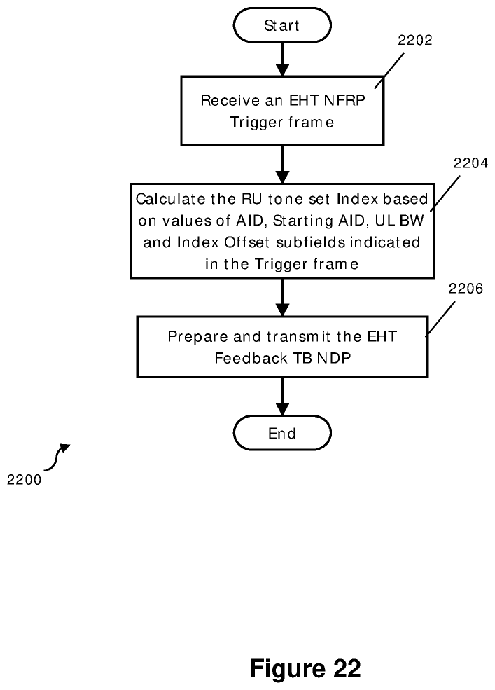

FIG. 22 depicts a flow diagram 2200 illustrating a process implemented by a STA in an enhanced NDP Feedback Report procedure according to the first embodiment of the present disclosure. The process starts with step 2202. In step 2202, an EHT NFRP Trigger frame is received. In step 2204, a step of calculating an RU tone set index based on values of AID, Starting AID, UL BW and Index Offset subfields indicated in the Trigger frame is carried out. In step 2206, a step of preparing, generating and transmitting an EHT Feedback TB NDP on frequency domain corresponding to the calculated RU tone set index is carried out.

With such simple parameter indicated in the trigger frame, the AP can control each assigned RU tone set to any higher 20 MHz subchannel.

In the following paragraphs, a second embodiment of the present disclosure where a parameter comprising a bandwidth offset value is used as frequency domain information to indicate a frequency domain within a STA's operating channel to transmit its feedback response is described.

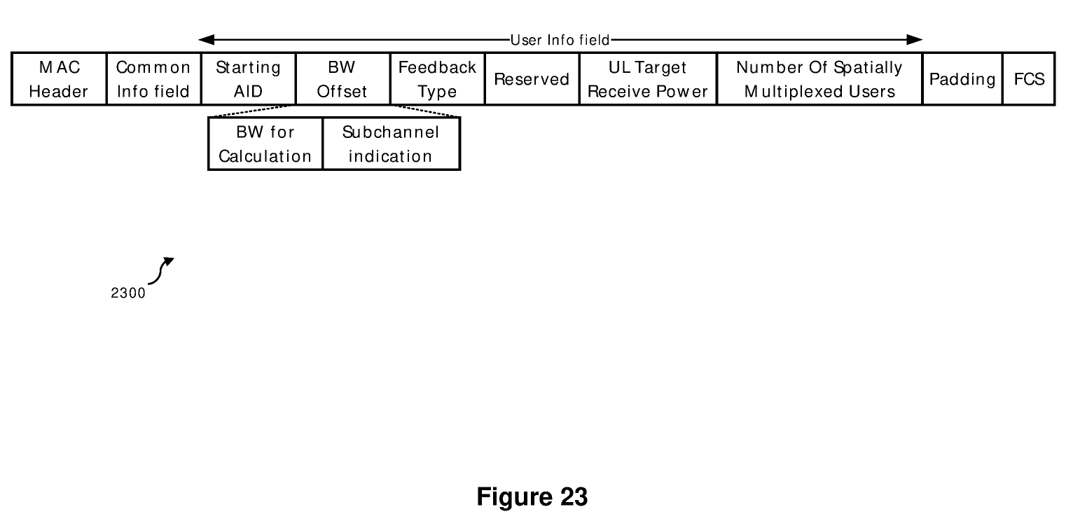

FIG. 23 depicts an example format of an EHT NFRP Trigger frame 2300 according to the second embodiment of the present disclosure. The EHT NFRP Trigger frame 2300 comprises a MAC Header (Frame Control field, Duration field, RA field and TA field), a Common Info field, a User Info field, a Padding field and a FCS field. The User Info field comprises a Starting AID subfield, a BW Offset subfield, a Feedback Type subfield, a UL Target Receive Power subfield and a Number Of Spatially Multiplexed Users subfield. The BW Offset subfield further comprises a BW for Calculation subfield and a Subchannel Indication subfield.

The BW for Calculation subfield of the BW Offset field indicates a new value of BW used in calculation phase and the resolution for the subchannel indicated in the Subchannel Indication subfield and the Subchannel Indication subfield of the BW Offset field indicates the position of subchannel where the assigned RU tone set is located in. The encoding of the BW for Calculation subfield and Subchannel Indication subfield is shown in Tables 1 and 2, respectively.

Table 1 shows various indications/meanings corresponding to different values of the BW for Calculation subfield.

| Value | Meaning |
|---|---|
| 0 | Conventional NFRP TF |
| 1 | 20 MHz |
| 2 | 80 MHz |
| 3 | 160 MHz |

Table 2 shows various indications/meanings corresponding to different values of the Subchannel Indication subfield.

| Value | Meaning |
|---|---|
| 0 | The 1^{st} lowest subchannel |
| 1 | The 2^{nd} lowest subchannel |
| . . . | . . . |
| 7 | The 8^{th} lowest subchannel |

Additionally or alternatively, the HE/EHT P160 subfield of the Common Info field (see FIG. 17) can be used to indicate in which 160 MHz subchannel the EHT TB Feedback NDP is transmitted on, so the Subchannel Indication subfield only needs to indicate position in a 160 MHz range.

Upon receipt of the EHT NFRP Trigger frame, associated non-AP STA(s) that satisfies feedback conditions will calculate RU tone set index based on values of AID, Starting AID, UL BW and BW Offset subfields. If the value of BW for Calculation subfield is 0, conventional NDP Feedback Report is indicated, and the process implemented by the non-AP STA(s) will be same as that defined in 802.11ax specification; whereas if the value of the BW for Calculation subfield is larger than 0, the non-AP STA(s) will calculate its RU tone set index and determine its corresponding RU tone set and frequency domain to transmit its feedback response according to equation (6), where NewBW is the value of BW for Calculation subfield and Nsubchannel is the value of the Subchannel Indication subfield.

$$RU\_TONE \_SET \_INDEX = 1 + ( ( AID - Starting AID ) mod ( 18 \times {2}^{NewBW} ) ) + {N}_{subchannel} \qquad Equation ( 6 )$$

It is noted that the AP shall determine such BW Offset carefully to avoid assignment of a same RU tone set index to more than one non-AP STAs.

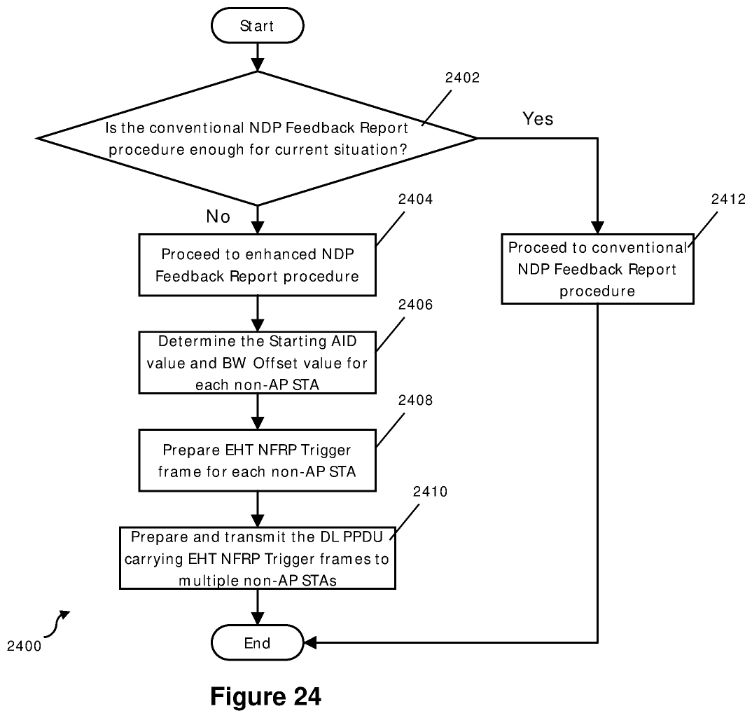

FIG. 24 depicts a flow diagram 2400 illustrating a process implemented by an AP in an enhanced NDP Feedback Report procedure according to the second embodiment of the present disclosure. The process starts with step 2402. In step 2402, a step of determining if the conventional NDP Feedback Report procedure is enough for the current situation. In an embodiment, in step 2402, the step of determining if the conventional NDP Feedback Report procedure is enough comprises a step of determining if all non-AP STAs can be supported in a single round of NDP Feedback Report procedure in either non-SST or SST scenario.

If it is determined that the convention NDP Feedback Report procedure is not enough, step 2404 is carried out; otherwise step 2412 is carried out. In step 2404, the process proceeds to an enhanced NDP Feedback Report procedure. In step 2406, a step of determining the Starting AID value and BW Offset value for each non-AP STA is carried out. In step 2408, a step of preparing and generating EHT NFRP Trigger frame for each non-AP STA is carried out. In step 2410, a step of preparing and transmitting a DL PPDU carrying the EHT NFRP Trigger frames to multiple non-AP STAs is carried out, and the process may end. Returning to step 2402, if it is determined that the convention NDP Feedback Report procedure is enough for the current situation, the conventional NDP Feedback Report procedure proceeds in step 2412 and the process may end after that.

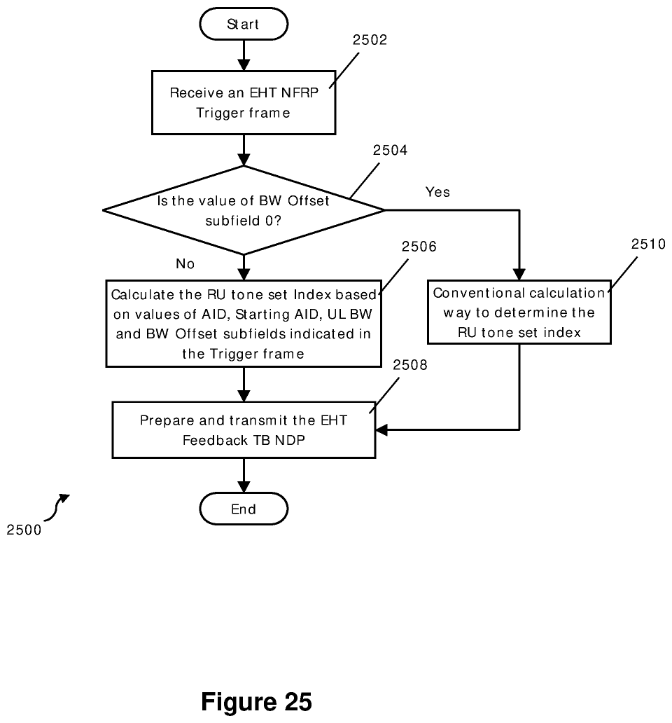

FIG. 25 depicts a flow diagram 2500 illustrating a process implemented by a STA in an enhanced NDP Feedback Report procedure according to the second embodiment of the present disclosure. The process starts with step 2502. In step 2502, an EHT NFRP Trigger frame is received. In step 2504, a step of determining if the value of BW Offset field is 0. If it is determined that the BW Offset field is not 0, step 2506 is carried out; otherwise step 2510 is carried out. In step 2506, a step of calculating an RU tone set index based on values of AID, Starting AID, UL BW and BW Offset fields indicated in the Trigger frame is carried out. In step 2508, a step of preparing, generating and transmitting an EHT Feedback TB NDP on frequency domain corresponding to the calculated RU tone set index is carried out. Returning to step 2504, if it is determined that the BW Offset field is 0, step 2510 is carried out where the conventional calculation way to determine the RU tone set index is carried out.

With such simple parameter indicated in the trigger frame, the AP can control each assigned RU tone set to any higher 20/80/160 MHz subchannel. The enhanced NDP Feedback procedure described in the second embodiment requires even less bits than that in the first embodiment.

In the following paragraphs, a third embodiment of the present disclosure where a parameter comprising a subchannel offset value is used as frequency domain information to indicate a frequency domain within a STA's operating channel to transmit its feedback response is described.

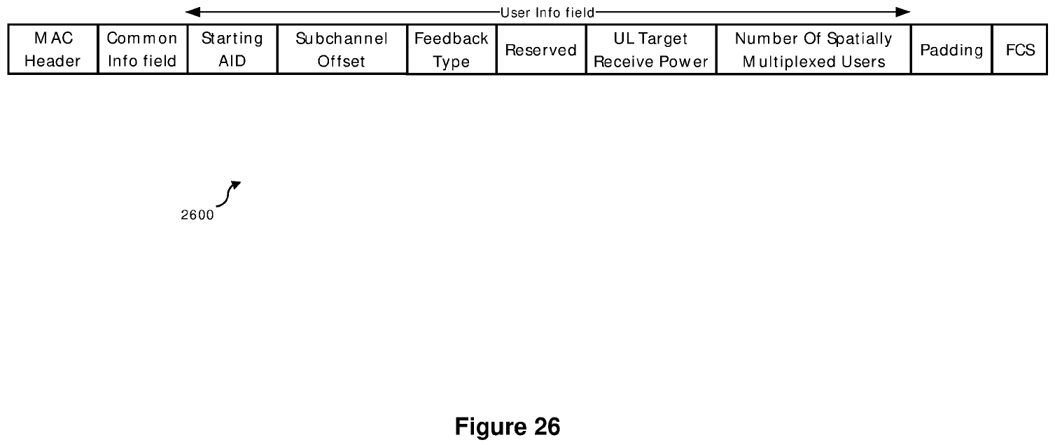

FIG. 26 depicts an example format of an EHT NFRP Trigger frame 2600 according to the third embodiment of the present disclosure. The EHT NFRP Trigger frame 2600 comprises a MAC Header (Frame Control field, Duration field, RA field and TA field), a Common Info field, a User Info field, a Padding field and a FCS field. The User Info field comprises a Starting AID subfield, Subchannel Offset subfield, a Feedback Type subfield, a UL Target Receive Power subfield and a Number Of Spatially Multiplexed Users subfield.

The Subchannel Offset field indicates the position of 20 MHz subchannel where the assigned RU tone set is located in the EHT TB Feedback NDP. The encoding of the Subchannel Offset field is shown in Table 3.

Table 3 shows various indications/meanings corresponding to different values of the Subchannel Offset field.

| Value | Meaning |
|---|---|
| 0 | The 1^{st} lowest 20 MHz |
| 1 | The 2^{nd} lowest 20 MHz |
| 2 | The 3^{rd} lowest 20 MHz |
| 3 | The 4^{th} lowest 20 MHz |
| 4 | The 5^{th} lowest 20 MHz |
| 5 | The 6^{th} lowest 20 MHz |
| 6 | The 7^{th} lowest 20 MHz |
| 7 | The 8^{th} lowest 20 MHz |

Additionally or alternatively, the HE/EHT P160 subfield of the Common Info field (see FIG. 17) can be used to indicate in which 160 MHz subchannel the EHT TB Feedback NDP is transmitted on, so the Subchannel Offset subfield only needs to indicate position in a 160 MHz range.

Upon receipt of the EHT NFRP Trigger frame, associated non-AP STA(s) that satisfies feedback conditions will calculate RU tone set index based on values of AID, Starting AID and Subchannel Offset subfields and determine its corresponding RU tone set and frequency domain to transmit its feedback responses according to equation (7), where Nsubchannel is the value of the Subchannel Offset subfield.

$$RU\_TONE \_SET \_INDEX = 1 + ( ( AID - Starting AID ) mod 18 ) + 18 \times {N}_{subchannel} \qquad Equation ( 7 )$$

In an embodiment, the AP may transmit more than one EHT NFRP Trigger frames to different non-AP STAs in a PPDU using multi-user (MU) transmission (e.g., MU-MIMO and/or OFDMA) or in an A-PPDU. Each EHT NFRP Trigger frame may comprise different Starting AID value and Subchannel Offset value.

It is noted that the AP shall determine such Subchannel Offset carefully to avoid assignment of a same RU tone set index to more than one non-AP STAs.

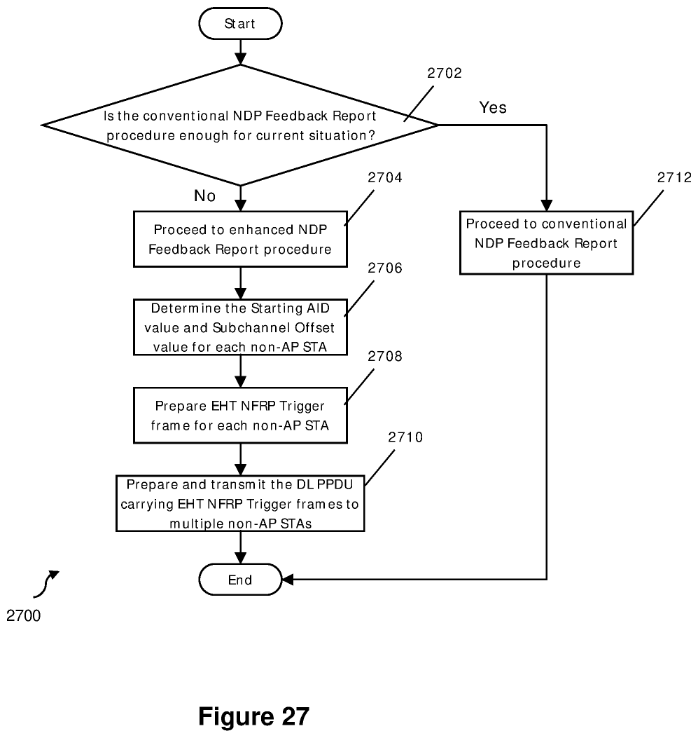

FIG. 27 depicts a flow diagram 2700 illustrating a process implemented by an AP in an enhanced NDP Feedback Report procedure according to the third embodiment of the present disclosure. The process starts with step 2702. In step 2702, a step of determining if the conventional NDP Feedback Report procedure is enough for the current situation. In an embodiment, in step 2702, the step of determining if the conventional NDP Feedback Report procedure is enough comprises a step of determining if all non-AP STAs can be supported in a single round of NDP Feedback Report procedure in either non-SST or SST scenario.

If it is determined that the convention NDP Feedback Report procedure is not enough, step 2704 is carried out; otherwise step 2712 is carried out. In step 2704, the process proceeds to an enhanced NDP Feedback Report procedure. In step 2706, a step of determining the Starting AID value and Subchannel Offset value for each non-AP STA is carried out. In step 2708, a step of preparing and generating EHT NFRP Trigger frame for each non-AP STA is carried out. In step 2710, a step of preparing and transmitting a DL PPDU carrying the EHT NFRP Trigger frames to multiple non-AP STAs is carried out, and the process may end. Returning to step 2702, if it is determined that the convention NDP Feedback Report procedure is enough for the current situation, the conventional NDP Feedback Report procedure proceeds in step 2712 and the process may end after that.

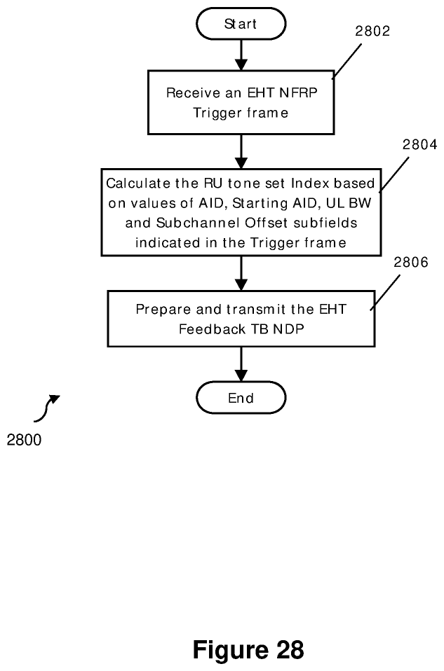

FIG. 28 depicts a flow diagram 2800 illustrating a process implemented by a STA in an enhanced NDP Feedback Report procedure according to the third embodiment of the present disclosure. The process starts with step 2802. In step 2802, an EHT NFRP Trigger frame is received. In step 2804, a step of calculating an RU tone set index based on values of AID, Starting AID, UL BW and Subchannel Offset subfields indicated in the Trigger frame is carried out. In step 2806, a step of preparing, generating and transmitting an EHT Feedback TB NDP on a frequency domain corresponding to the calculated RU tone set index is carried out.

With such simple parameter indicated in the trigger frame, the AP can control each assigned RU tone set to any higher 20 MHz subchannel. The enhanced NDP Feedback procedure described in the third embodiment requires even less bits than that in the first and second embodiments.

In the following paragraphs, a fourth embodiment of the present disclosure where an indication to indicate to a STA to adjust its RU tone set index to correspond to a frequency domain within a STA's operating channel to transmit its feedback response is described.

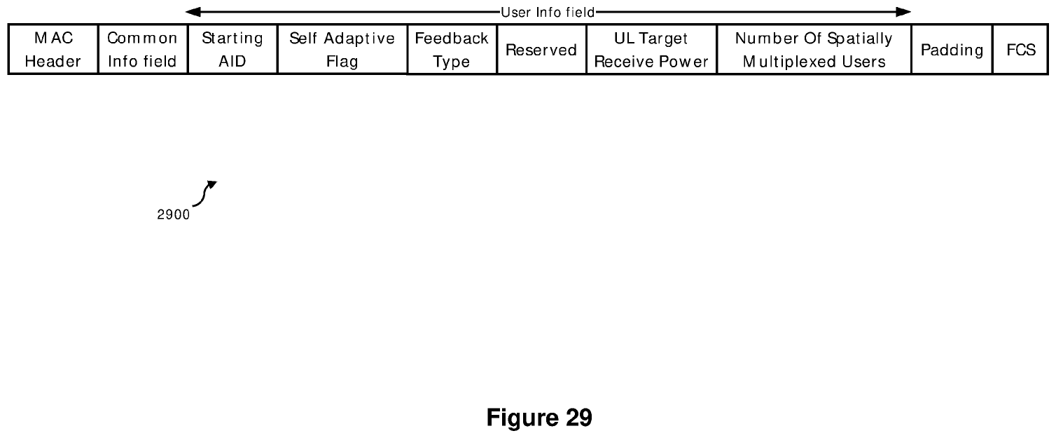

FIG. 29 depicts an example format of an EHT NFRP Trigger frame 2900 according to the fourth embodiment of the present disclosure. The EHT NFRP Trigger frame 2900 comprises a MAC Header (Frame Control field, Duration field, RA field and TA field), a Common Info field, a User info field, a Padding field and a FCS field. The User Info field comprises a Starting AID subfield, a Self Adaptive Flag subfield, a Feedback Type subfield, a UL Target Receive Power subfield and a Number Of Spatially Multiplexed Users subfield.

The Self Adaptive Flag subfield indicates whether the scheduled non-AP STAs should adapt the RU tone set index or not. The encoding of the Self Adaptive Flag subfield is shown in Table 4.

Table 4 shows indications/meanings corresponding to two different values of the Self Adaptive Flag subfield.

| Value | Meaning |
|---|---|
| 0 | Conventional NFRP TF |
| 1 | Self Adaptive NDP Feedback |
| | Report |

Upon receipt of the EHT NFRP Trigger frame, associated non-AP STA(s) that satisfies feedback conditions will calculate RU tone set index based on values of AID, Starting AID and UL BW subfields together with their parking subchannels. If the value of the Self Adaptive Flag subfield is 0, conventional NDP Feedback Report is indicated, and the process implemented by the non-AP STA(s) will be same as that defined in 802.11ax specification; whereas if the value of the Self Adaptive Flag subfield is 1, the non-AP STA(s) will determine the initial RU tone set index using equation (8).

$$RU\_TONE \_SET \_INDEX \_Initial = 1 + ( ( AID - Starting AID ) mod ( 18 \times {2}^{BW} ) ) \qquad Equation ( 8 )$$

If the initial RU tone set corresponds to a frequency domain within the non-non-AP STA(s)′ operating frequency range, the non-AP STA(s) will transmit on the RU tone set of the EHT TB Feedback NDP, i.e., RU_TONE_SET_INDEX=RU_TONE_SET_INDEX_Initial.

If the initial RU tone set corresponds to a frequency domain outside of the non-AP STA(s)′ operating frequency range, the non-AP STA(s) will shift the index from the initial RU tone set index to a closest index that corresponds to a frequency domain within the non-AP STA's operating frequency range, and the bandwidth of solicited EHT TB Feedback NDP. The shifted RU tone set index is illustrated in equation (9), where OffsetValue is an offset value decided by the non-AP STA(s).

$$RU\_TONE \_SET \_INDEX = RU\_TONE \_SET \_INDEX \_Initial \pm OffsetValue \qquad Equation ( 9 )$$

With the Self Adaptive Flag subfield indicated, the non-AP STAs can control the assigned RU tone set index to fall on a certain frequency segment by itself.

In one embodiment, the AP may transmit more than one EHT NFRP Trigger frames to different non-AP STAs in a PPDU using multi-user (MU) transmission (e.g., MU-MIMO and/or OFDMA) or in an A-PPDU. Each EHT NFRP Trigger frame may comprise different Starting AID value and Self Adaptive Flag value.

It is noted that the AP shall send an EHT NFRP Trigger frame with Self Adaptive Flag subfield set to “1” to a non-AP STA if the shifted RU tone set index will collide with other RU tone set index.

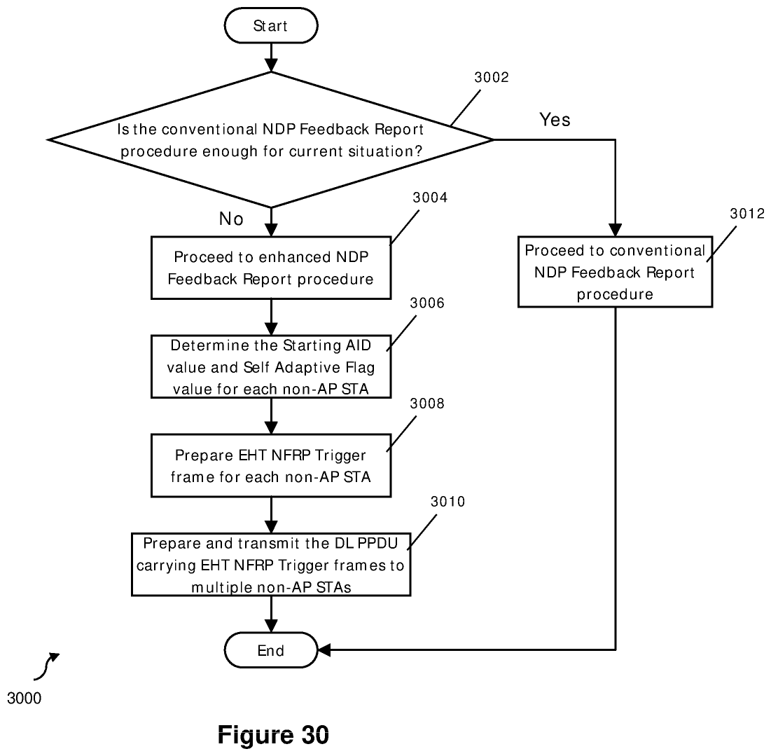

FIG. 30 depicts a flow diagram 3000 illustrating a process implemented by an AP in an enhanced NDP Feedback Report procedure according to the fourth embodiment of the present disclosure. The process starts with step 3002. In step 3002, a step of determining if the conventional NDP Feedback Report procedure is enough for the current situation. In an embodiment, in step 3002, the step of determining if the conventional NDP Feedback Report procedure is enough comprises a step of determining if all non-AP STAs can be supported in a single round of NDP Feedback Report procedure in either non-SST or SST scenario.

If it is determined that the convention NDP Feedback Report procedure is not enough, step 3004 is carried out; otherwise step 3012 is carried out. In step 3004, the process proceeds to an enhanced NDP Feedback Report procedure. In step 3006, a step of determining the Starting AID value and Self Adaptive Flag value for each non-AP STA is carried out. In step 3008, a step of preparing and generating EHT NFRP Trigger frame for each non-AP STA is carried out. In step 3010, a step of preparing and transmitting a DL PPDU carrying the EHT NFRP Trigger frames to multiple non-AP STAs is carried out, and the process may end. Returning to step 3002, if it is determined that the convention NDP Feedback Report procedure is enough for the current situation, the conventional NDP Feedback Report procedure proceeds in step 3012 and the process may end after that.

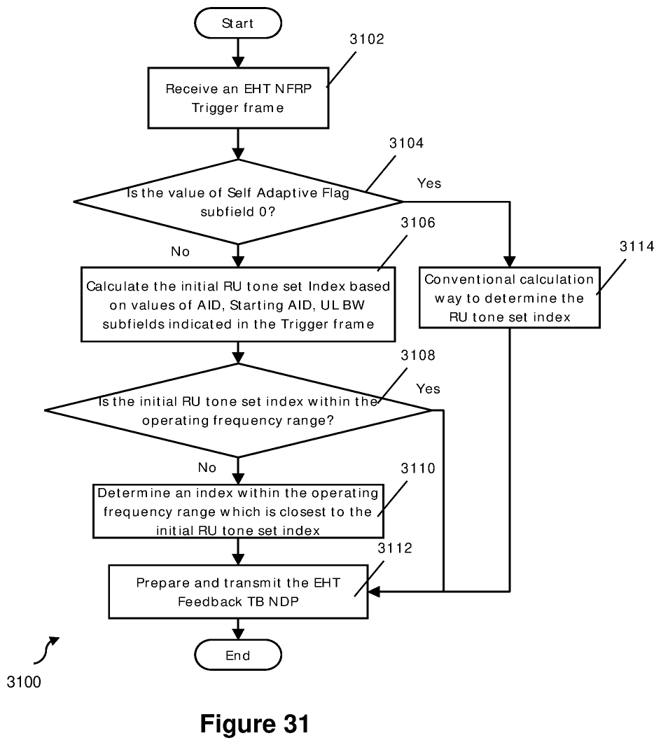

FIG. 31 depicts a flow diagram 3100 illustrating a process implemented by a STA in an enhanced NDP Feedback Report procedure according to the fourth embodiment of the present disclosure. The process starts with step 3102. In step 3102, an EHT NFRP Trigger frame is received. In step 3104, a step of determining if the value of Self Adaptive Flag subfield is 0. If it is determined that the value of Self Adaptive Flag subfield is not 0, step 3106 is carried out; otherwise step 3114 is carried out. In step 3106, a step of calculating an initial RU tone set index based on values of AID, Starting AID and UL BW subfields indicated in the Trigger frame is carried out. In step 3108, a step of determining if the initial RU tone set index is within the operating frequency range of the STA. If it is determined that the initial RU tone set index falls within the STA's operating frequency range, step 3112 is carried out; otherwise step 3110 is carried out. In step 3110, a step of determining a RU tone set index within its operating frequency range which is closest to the initial RU tone set index. In step 3112, a step of preparing, generating and transmitting an EHT Feedback TB NDP on frequency domain corresponding to the RU tone set index is carried out. Returning to step 3104, if it is determined that the Self Adaptive Flag subfield is 0, step 3114 is carried out where the conventional calculation way to determine the RU tone set index is carried out.

With this Self Adaptive Flag subfield and indication, the non-AP STAs can adjust the RU tone set index by itself. However, careful schedule in AP side is needed. The enhanced NDP Feedback procedure described in this fourth embodiment are less flexible as compared to the first, second and third embodiments.

In the following paragraphs, a fifth embodiment of the present disclosure where a parameter comprising a new Modulo or Modulation value is used as frequency domain information to indicate a frequency domain within a STA's operating channel to transmit its feedback response is described.

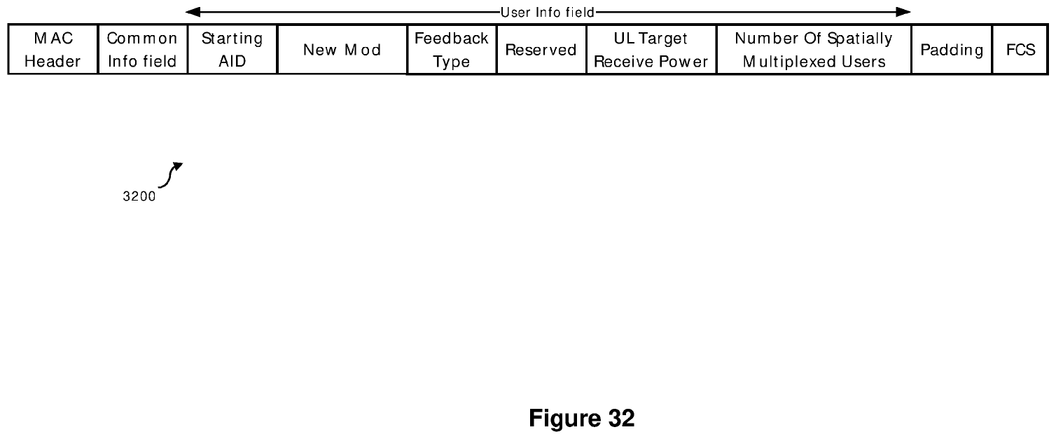

FIG. 32 depicts an example format of an EHT NFRP Trigger frame 3200 according to a first example of the fifth embodiment of the present disclosure. The EHT NFRP Trigger frame 3200 comprises a MAC Header (Frame Control field, Duration field, RA field and TA field), a Common Info field, a User Info field, a Padding field and a FCS field. The User Info field comprises a Starting AID subfield, a New Mod subfield, a Feedback Type subfield, a UL Target Receive Power subfield and a Number Of Spatially Multiplexed Users subfield.

The New Mod field indicates the modulo or modulation value used in calculation phase. The encoding of the New Mod subfield is shown in Table 5.

Table 5 shows various indications/meanings corresponding to different values of the New Mod subfield.

| Value | Meaning |
|---|---|
| 0 | Modulo = 18 |
| 1 | Modulo = 36 |
| 2 | Modulo = 72 |
| 3 | Modulo = 144 |
| 4 | Modulo = 288 |
| 5 | Modulo = 576 |
| 6 | Modulo = 1152 |
| 7 | Modulo = 2304 |

Upon receipt of the EHT NFRP Trigger frame, associated non-AP STA(s) that satisfies feedback conditions will calculate RU tone set index based on values of AID, Starting AID and New Mod subfields and determine its RU tone set to transmit using equation (10), where the NewMod is the modulo value indicated in the New Mod subfield.

$$RU\_TONE \_SET \_INDEX = 1 + ( ( AID - Starting AID ) mod ( New Mod ) ) \qquad Equation ( 10 )$$

In addition, the non-AP STA(s) determines the assigned spatial stream using equation (11).

$$STARTING\_STS \_NUM = ( AID - STARTING AID ) / New Mod \qquad Equation ( 11 )$$

For example, an AP solicits a 40 MHz EHT TB Feedback NDP from all non-AP STAs with starting AID of 1, and out of which, a non-AP STA is under AID 26. If the value of New Mod subfield is set to 18×2^{BW}, the non-AP STA will calculate the RU tone set index as 26 on spatial stream #0. If the value of New Mod subfield is set to 18, the non-AP STA will calculate the RU tone set index as 8 on spatial stream #1.

With such New Mod subfield value added to the equation, the AP can control each assigned RU tone set to a lower value such that the assigned RU set call fall on another 20 MHz subchannel. However, the position of the RU tone set inside the 20 MHz subchannel cannot be controlled.

In an embodiment, the AP may transmit more than one EHT NFRP Trigger frames to different non-AP STAs in a PPDU using multi-user (MU) transmission (e.g., MU-MIMO and/or OFDMA) or in an A-PPDU. Each EHT NFRP Trigger frame may comprise different Starting AID value and New Mod value.

It is noted that the AP shall determine the New Mod carefully to avoid assignment of a same RU tone set index to more than one non-AP STAs.

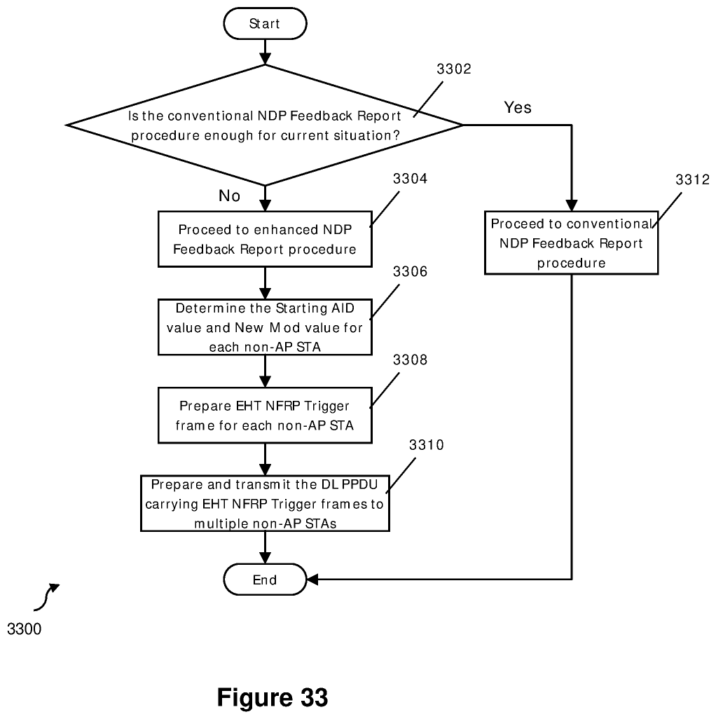

FIG. 33 depicts a flow diagram 3300 illustrating a process implemented by an AP in an enhanced NDP Feedback Report procedure according to the first example of the fifth embodiment of the present disclosure. The process starts with step 3302. In step 3302, a step of determining if the conventional NDP Feedback Report procedure is enough for the current situation. In an embodiment, in step 3302, the step of determining if the conventional NDP Feedback Report procedure is enough comprises a step of determining if all non-AP STAs can be supported in a single round of NDP Feedback Report procedure in either non-SST or SST scenario.

If it is determined that the convention NDP Feedback Report procedure is not enough, step 3304 is carried out; otherwise step 3312 is carried out. In step 3304, the process proceeds to an enhanced NDP Feedback Report procedure. In step 3306, a step of determining the Starting AID value and New Mod value for each non-AP STA is carried out. In step 3308, a step of preparing and generating EHT NFRP Trigger frame for each non-AP STA is carried out. In step 3310, a step of preparing and transmitting a DL PPDU carrying the EHT NFRP Trigger frames to multiple non-AP STAs is carried out, and the process may end. Returning to step 3302, if it is determined that the convention NDP Feedback Report procedure is enough for the current situation, the conventional NDP Feedback Report procedure proceeds in step 3312 and the process may end after that.

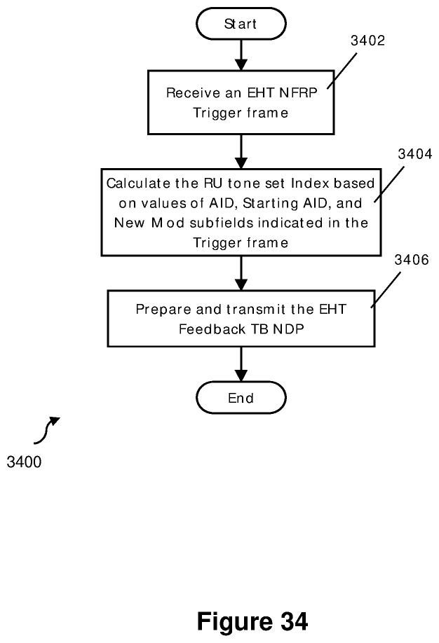

FIG. 34 depicts a flow diagram 3400 illustrating a process implemented by a STA in an enhanced NDP Feedback Report procedure according to the first example of the fifth embodiment of the present disclosure. The process starts with step 3402. In step 3402, an EHT NFRP Trigger frame is received. In step 3404, a step of calculating an RU tone set index based on values of AID, Starting AID and new Mod subfields indicated in the Trigger frame is carried out. In step 3406, a step of preparing, generating and transmitting an EHT Feedback TB NDP on frequency domain corresponding to the RU tone set index is carried out.

With such simple parameter indicated in the trigger frame, the AP can control some assigned RU tone sets to a different 20 MHz subchannel. The enhanced NDP Feedback procedure described in this example of the fifth embodiment is less flexible as compared to the first, second and third embodiments.

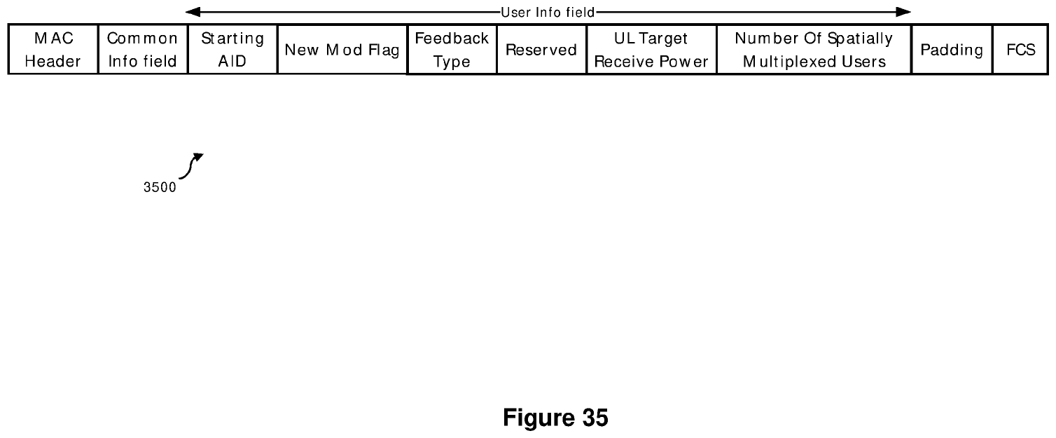

Alternatively, instead of indicating New Mod value, a New Mod Flag is indicated. FIG. 35 depicts an example format of an EHT NFRP Trigger frame 3500 according to a second example of the fifth embodiment of the present disclosure. The EHT NFRP Trigger frame 3500 comprises a MAC Header (Frame Control field, Duration field, RA field and TA field), a Common Info field, a User Info field, a Padding field and a FCS field. The User Info field comprises a Starting AID subfield, a New Mod Flag subfield, a Feedback Type subfield, a UL Target Receive Power subfield and a Number Of Spatially Multiplexed Users subfield.

The New Mod Flag field indicates whether a new 2007-basis modulo rule is applied. It is noted, instead of 2007, other pre-defined/fixed value that is reasonable and large enough can be used, e.g., 5005-basis module rule. In addition, if 2007-basis modulo rule (or other rule) is used, the value of Starting AID should be set properly to support the rule. The encoding of the New Mod Flag subfield is shown in Table 6.

Table 6 shows various indications/meanings corresponding to different values of the New Mod subfield.

| Value | Meaning |
|---|---|
| 0 | Conventional NDP Feedback Report |
| 1 | 2007-basis modulo rule is applied |

If the value of the New Mod Flag subfield is 0, conventional NDP Feedback Repot procedure is indicated, and the non-AP STA determines it is scheduled to respond to the EHT NFRP Trigger frame in a same way as that defined according to 802.11ax specification. If the value of the New Mod Flag subfield is 1, 2007-basis module is applied and the non-AP STA determines whether it is scheduled to respond to the EHT NFRP Trigger frame with the feedback conditions that the non-AP STA's AID is less than starting AID+N_{STA}−2007 using the Starting AID subfield in the eliciting Trigger frame, where N_{STA} is the total number of non-AP STAs that are scheduled to respond to the NFRP Trigger frame, calculated in the same way as that defined according to 802.11ax specification.

Upon receipt of the EHT NFRP Trigger frame, associated non-AP STA(s) that satisfies the feedback conditions will calculate RU tone set index based on values of AID subfield and Starting AID subfield and modulo value 2007 and and determine its corresponding RU tone set and frequency domain to transmit its feedback responses according to equation (12).

$$RU\_TONE \_SET \_INDEX = 1 + ( ( AID - ( Starting AID - 2007 ) ) mod ( 2007 ) ) \qquad Equation ( 12 )$$

For example, an AP solicits a 40 MHz EHT TB Feedback NDP from some non-AP STAs, and one of which is a non-AP STA with AID 7. If the value of New Mod Flag subfield is 0, i.e., 2007-basis modulo rule is not applied, and the Starting AID subfield is set to 1 the non-AP STA will calculate the RU tone set index as 7. If the value of New Mod Flag subfield is 1, i.e., 2007-basis modulo rule is applied, and the Starting AID subfield is set to 1990, the non-AP STA will calculate the RU tone set index as 24.

With such New Mod Flag subfield indicating the 2007-basis modulo rule, the AP can control each assigned RU tone set to a higher value such that the assigned RU set call fall on a higher 20 MHz subchannel.

In an embodiment, the AP may transmit more than one EHT NFRP Trigger frames to different non-AP STAs in a PPDU using multi-user (MU) transmission (e.g., MU-MIMO and/or OFDMA) or in an A-PPDU. Each EHT NFRP Trigger frame may comprise different Starting AID value and New Mod Flag value.

It is noted that the AP shall schedule the target receivers of an EHT NFRP Trigger frame indicating 2007-basis modulo rule carefully to avoid assignment of a same RU tone set index to more than one non-AP STAs.

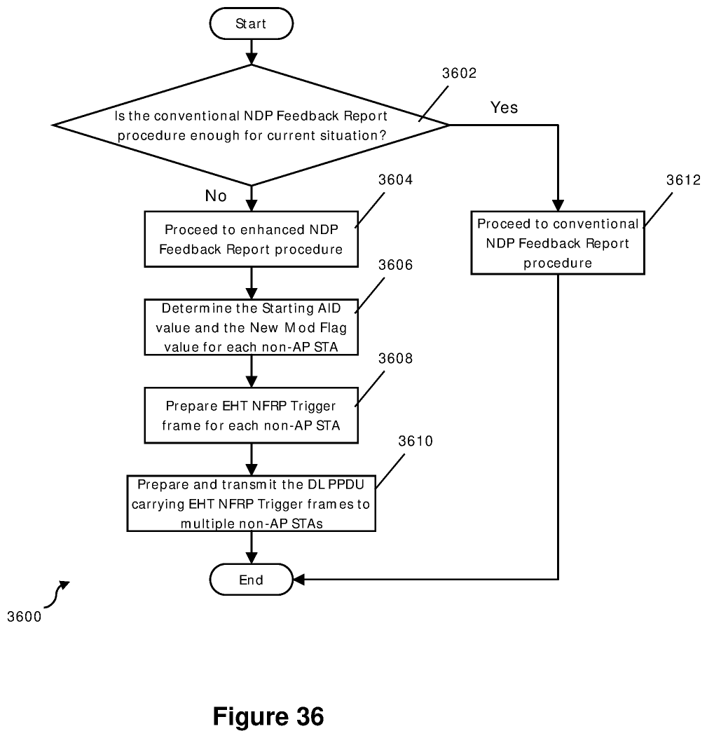

FIG. 36 depicts a flow diagram 3600 illustrating a process implemented by an AP in an enhanced NDP Feedback Report procedure according to the second example of the fifth embodiment of the present disclosure. The process starts with step 3602. In step 3602, a step of determining if the conventional NDP Feedback Report procedure is enough for the current situation. In an embodiment, in step 3602, the step of determining if the conventional NDP Feedback Report procedure is enough comprises a step of determining if all non-AP STAs can be supported in a single round of NDP Feedback Report procedure in either non-SST or SST scenario.

If it is determined that the convention NDP Feedback Report procedure is not enough, step 3604 is carried out; otherwise step 3612 is carried out. In step 3604, the process proceeds to an enhanced NDP Feedback Report procedure. In step 3606, a step of determining the Starting AID value and New Mod value for each non-AP STA is carried out. In step 3608, a step of preparing and generating EHT NFRP Trigger frame for each non-AP STA is carried out. In step 3610, a step of preparing and transmitting a DL PPDU carrying the EHT NFRP Trigger frames to multiple non-AP STAs is carried out, and the process may end. Returning to step 3602, if it is determined that the convention NDP Feedback Report procedure is enough for the current situation, the conventional NDP Feedback Report procedure proceeds in step 3612 and the process may end after that.

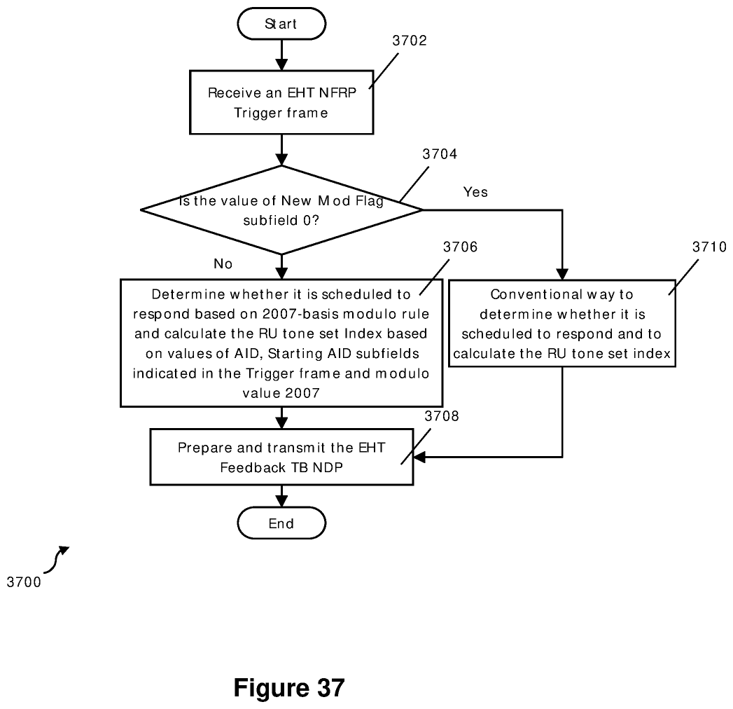

FIG. 37 depicts a flow diagram 3700 illustrating a process implemented by a STA in an enhanced NDP Feedback Report procedure according to the second example of the fifth embodiment of the present disclosure. The process starts with step 3702. In step 3702, an EHT NFRP Trigger frame is received. In step 3704, a step of determining if the value of the New Mod Flag subfield is 0. If it is determined that the New Mod Flag subfield value is not 0, step 3706 is carried out; otherwise step 3710 is carried out. In step 3706, a step of determining whether the STA is scheduled to respond based on 2007-basis modulo rule and calculating an RU tone set index based on values of AID and Starting AID subfields indicated in the Trigger frame and modulo value 2007 is carried out. In step 3708, a step of preparing, generating and transmitting an EHT Feedback TB NDP on frequency domain corresponding to the RU tone set index is carried out. Returning to step 3704, if it is determined that the New Mod Flag subfield value is 0, step 3710 is carried out where the conventional calculation way to determine whether the STA is schedule to respond and calculate the RU tone set index is carried out.

With such simple parameter indicated in the trigger frame, the AP can control some assigned RU tone sets to a different 20 MHz subchannel with a different rule. The enhanced NDP Feedback procedure described in this example of the fifth embodiment has the same performance as that of the first, second and third embodiments.

In the following paragraphs, a sixth embodiment of the present disclosure where bandwidth and position information in a signal field(s) is used as frequency domain information to indicate a frequency domain within a STA's operating channel to transmit its feedback response is described.

Similar to soliciting a TB A-PPDU, an AP can send one or more EHT NFRP Trigger frame to solicit an Aggregated TB Feedback NDP from non-AP STAs. The bandwidth information for each HE/EHT TB Feedback NDP in the aggregated TB Feedback NDP is indicated in EHT NFRP Trigger frame(s).

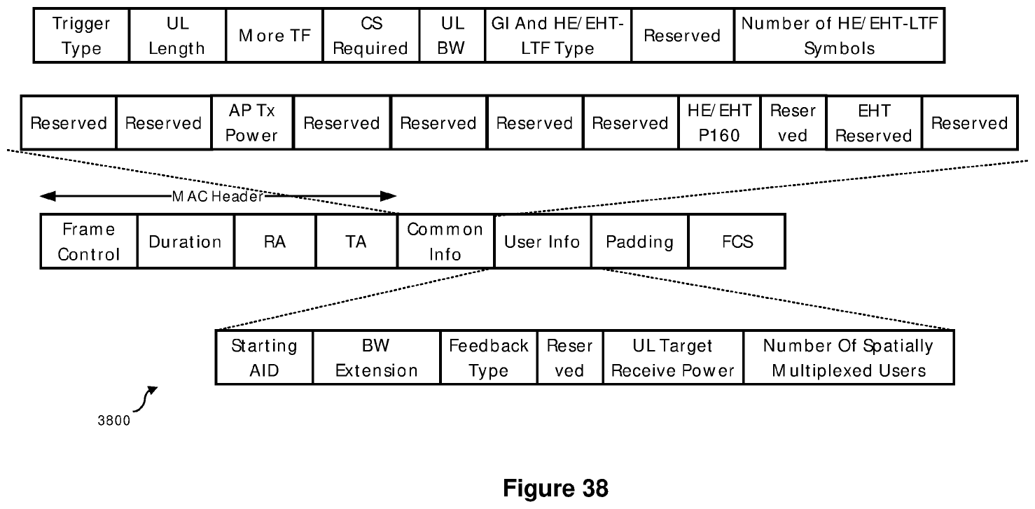

FIG. 38 depicts an example format of an EHT NFRP Trigger frame 3800 according to the sixth embodiment of the present disclosure. The EHT NFRP Trigger frame 3800 comprises a Frame Control field, a Duration field, a RA field, a TA field, a Common Info field, a User Info field, a Padding field and a FCS field. The Frame Control field, the Duration field, the RA field and the TA field may be grouped as MAC header. The Common field consists of a Trigger Type subfield, a UL Length subfield, a More TF subfield, a CS Required subfield, a UL BW subfield, a GI And HE-LTF Type subfield, a Number OF HE/EHT-LTF Symbols subfield, an AP Tx Power subfield, a HE/EHT P160 subfield and an EHT Reserved subfield. The User Info field comprises a Starting AID subfield, a BW Extension field, a Feedback Type subfield, a UL Target Receive Power subfield and a Number Of Spatially Multiplexed Users subfield.

The UL BW subfield of the Common Info field indicates a bandwidth of the solicited HE/EHT TB Feedback NDP that overlaps the primary channel. The BW Extension subfield of the User Info field indicates the bandwidth and the position of the solicited EHT TB Feedback NDP that does not overlap the primary channel. The encoding of the BW Extension subfield is shown in Table 7.

Table 7 shows various indications/meanings corresponding to different values of the BW Extension subfield.

| Value | Meaning |
|---|---|
| 0~7 | 20 MHz in 8 subchannels from |
| | low to high |
| 8~11 | 80 MHz in 2 subchannels from |
| | low to high |
| 12~13 | 160 MHz |

Additionally or alternatively, the HE/EHT P160 subfield of the Common Info field (see FIG. 38) can be used to indicate in which 160 MHz subchannel the EHT TB Feedback NDP is transmitted on, so the BW Extension subfield only needs to indicate position in a 160 MHz range.

According to the sixth embodiment, a non-AP STA is scheduled to respond to the EHT NFRP Trigger frame if the non-AP STA's AID is greater than or equal to the starting AID and less than starting AID+N_{STA} where starting AID value is the value of the Starting AID subfield and N_{STA} is total number of non-AP STAs that are scheduled to respond to the NFRP Trigger frame. N_{STA} is calculated using equations (13)-(15), where N_{STA}1 is the total number of non-AP STAs that are scheduled to respond to the primary NDP, N_{STA}2 is the total number of non-AP STAs that are scheduled to respond on the secondary NDP, BW1 is the value of the UL BW subfield, BW2 is the value of the BW Extension subfield and MultuplexingFlag is the value of the Number Of Spatially Multiplexed Users subfield.

$${N}_{STA} 1 = 18 \times {2}^{BW 1} \times ( MultiplexingFlag + 1 ) \qquad Equation ( 13 )$$

$${N}_{STA} 2 = 18 \times {2}^{BW 2} \times ( MultiplexingFlag + 1 ) \qquad Equation ( 14 )$$

$${N}_{STA} = {N}_{STA} 1 + {N}_{STA} 2 \qquad Equation ( 15 )$$

In an embodiment, the AP may transmit one EHT NFRP Trigger frame to all non-AP STAs in a DL PPDU with full bandwidth transmission if allowed. In an alternative embodiment, the AP may transmit more than one EHT NFRP Trigger frames to different non-AP STAs in a PPDU using multi-user (MU) transmission (e.g., MU-MIMO and/or OFDMA) or in an A-PPDU. Each EHT NFRP Trigger frame may comprise different BW Extension subfield value

Upon receipt of the EHT NFRP Trigger frame, associated non-AP STA(s) that satisfies feedback conditions will calculate RU tone set index based on values of AID, Starting AID, UL BW and BW Extension subfields. The non-AP STA(s) first determines which EHT TB Feedback NDP it can transmit. If only one EHT TB Feedback NDP is overlapping its operating frequency range, the non-AP STA will calculate its RU tone set index in the same way as that defined in 802.11ax specification, and transmit on the assigned RU tone set of the EHT TB Feedback NDP.

If two or more EHT TB Feedback NDPs are overlapping with its operating frequency range, the non-AP STA will determine the RU tone set. The steps of determining the RU tone set comprises a first step of calculating an initial RU tone set index which overlaps with the primary channel based on the UL BW subfield using equation (8).

If the initial RU tone set corresponds to a frequency domain within the non-non-AP STA's operating frequency range, the non-AP STA(s) will transmit on the RU tone set of the EHT TB Feedback NDP, i.e., RU_TONE_SET_INDEX=RU_TONE_SET_INDEX_Initial, overlapping with the primary channel.

If the initial RU tone set corresponds to a frequency domain outside of the non-AP STA's operating frequency range, the non-AP STA(s) will then calculate a second RU tone set index which does not overlap the primary channel based on the BW Extension subfield using equation (16), where BWExtension is the bandwidth indicated in the BW Extension subfield.

$$RU\_TONE \_SET \_INDEX \_Second = 1 + ( ( AID - Starting AID ) mod ( 18 \times {2}^{{BW}_{Extension}} ) ) \qquad Equation ( 16 )$$

If the second RU tone set corresponds to a frequency domain within the non-AP STA's operating frequency range, the non-AP STA will transmit on the RU tone set of the EHT TB Feedback NDP, i.e., RU_TONE_SET_INDEX=RU_TONE_SET_INDEX_Second, not overlapping the primary channel.

With the BW Extension subfield, the AP can control the assigned RU tone set index to fall on a certain EHT TB Feedback NDP.

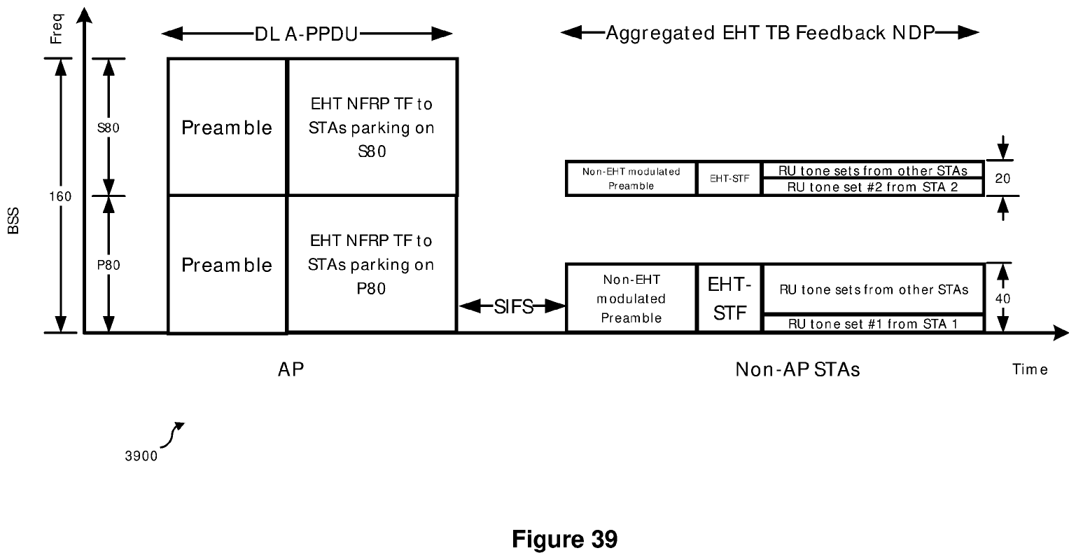

FIG. 39 depicts a diagram 3900 illustrating an example enhanced NDP Feedback Report procedure according to the sixth embodiment of the present disclosure. there is a 160 MHz BSS. Out of a total of 40 non-AP STAs associated with an AP within the BSS, 36 non-AP STAs park on the primary 80 MHZ (P80); 4 non-AP STAs park on the secondary 80 MHZ (S80). STA1 with AID 1 is one of the 36 non-AP STAs parking on the P80 and STA2 with AID 2 is one of the 4 non-AP STAs parking on the S80.

The AP sends an EHT NFRP Trigger frame soliciting an Aggregated EHT TB Feedback NDP with 40 MHz NDP on the P80 and 20 MHZ NDP on the S80. The EHT NFRP Trigger frame is sent to all STAs, the Starting AID subfield is set to 1; the UL BW subfield is set to 80 MHz; and the BW Extension subfield is set to 0 indicating 20 MHz NDP on the 5th lowest 20 MHz.

Upon receipt of the EHT NFRP Trigger frame, STA1 calculates its assigned RU tone set index on the 40 MHz as 1 and thus transmits on RU tone set index #1 of the 40 MHz EHT TB Feedback NDP on the P80 whereas STA2 calculates its assigned RU tone set index as 2 and thus transmits on RU tone set index #2 of the 20 MHZ EHT TB Feedback on the S80. As a result, all non-AP STAs parking on different subchannels can be supported in a single round of NDP Feedback Report procedure.

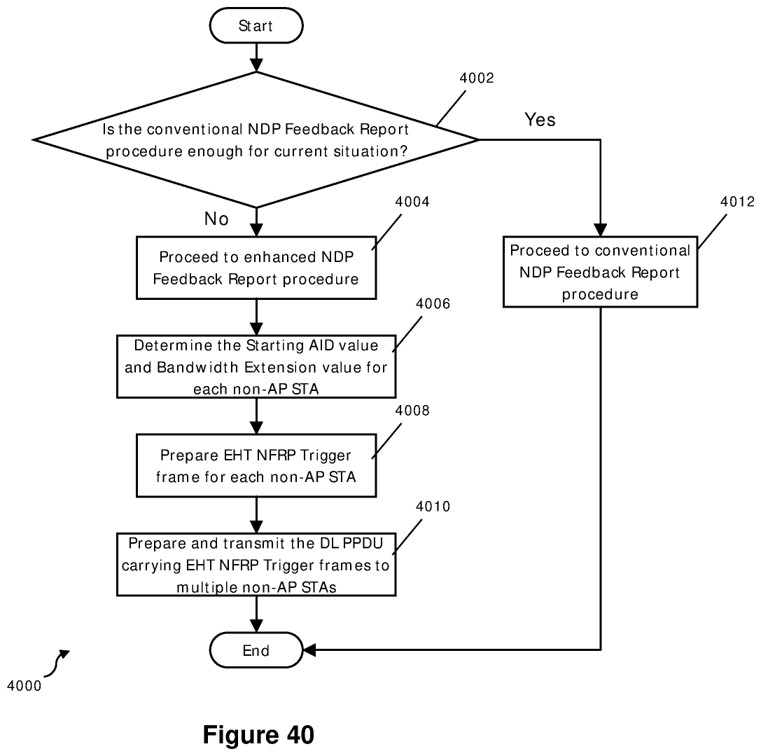

FIG. 40 depicts a flow diagram 4000 illustrating a process implemented by an AP in an enhanced NDP Feedback Report procedure according to the second example of the sixth embodiment of the present disclosure. The process starts with step 4002. In step 4002, a step of determining if the conventional NDP Feedback Report procedure is enough for the current situation. In an embodiment, in step 4002, the step of determining if the conventional NDP Feedback Report procedure is enough comprises a step of determining if all non-AP STAs can be supported in a single round of NDP Feedback Report procedure in either non-SST or SST scenario.

If it is determined that the convention NDP Feedback Report procedure is not enough, step 4004 is carried out; otherwise step 4012 is carried out. In step 4004, the process proceeds to an enhanced NDP Feedback Report procedure. In step 4006, a step of determining the Starting AID value and Bandwidth Extension value for each non-AP STA is carried out. In step 4008, a step of preparing and generating EHT NFRP Trigger frame for each non-AP STA is carried out. In step 4010, a step of preparing and transmitting a DL PPDU, with full bandwidth or MU-MIMO/OFDMA transmission, carrying the EHT NFRP Trigger frames to multiple non-AP STAs is carried out, and the process may end. Returning to step 4002, if it is determined that the convention NDP Feedback Report procedure is enough for the current situation, the conventional NDP Feedback Report procedure proceeds in step 4012 and the process may end after that.

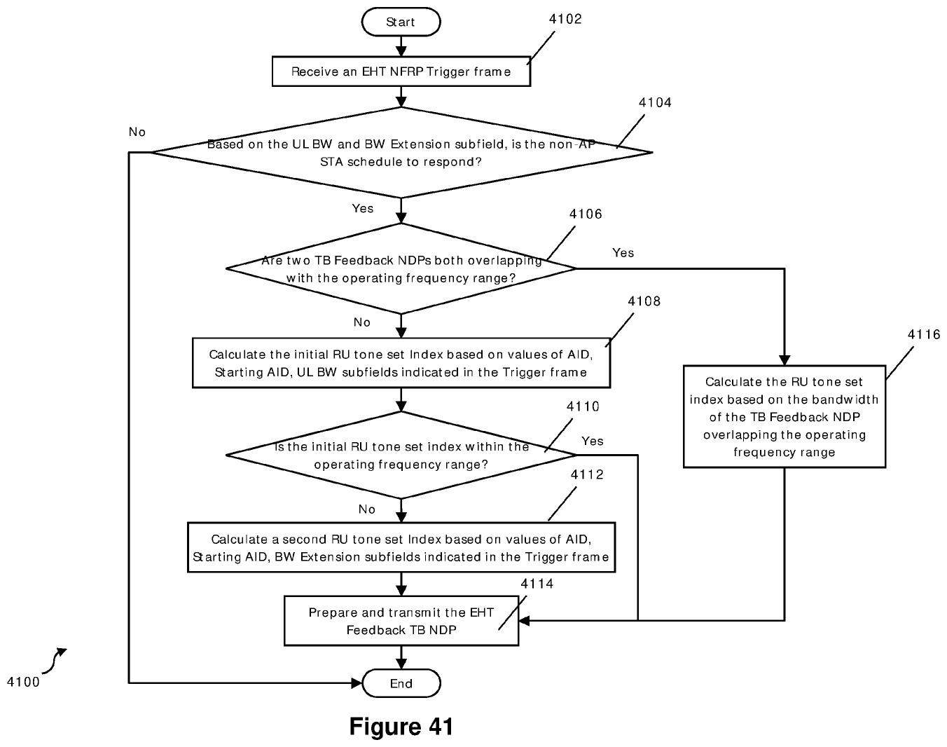

FIG. 41 depicts a flow diagram 4100 illustrating a process implemented by a STA in an enhanced NDP Feedback Report procedure according to the sixth embodiment of the present disclosure. The process starts with step 4102. In step 4102, an EHT NFRP Trigger frame is received. In step 4104, a step of determining, based on the UL BW and BW Extension subfields, if the non-AP STA is scheduled to respond. If it is determined that the non-AP STA is scheduled to respond, step 4106 is carried out; otherwise the process may end. In step 4106, a step of determining if two TB Feedback NDPs are both overlapping with the STA's operating frequency range. If it is determined that the two TB Feedback NDPs do not overlap its operating frequency range, step 4108 is carried out; otherwise, step 4114 is carried out. In step 4108, a step of calculating an initial RU tone set index based on values of AID, Starting AID and UL BW subfields indicated in the Trigger frame is carried out. In step 4110, a step of determining if the initial RU tone set index is within the STA's operating frequency range. If it is determined that the initial RU tone set index falls within the STA's operating frequency range, step 4112 is carried out; otherwise step 4114 is carried out. In step 4112, a step of calculating a second tone set index based on values of AID, Starting AID, BW Extension subfields indicated in the Trigger frame is carried out. In step 4114, a step of preparing, generating and transmitting an EHT Feedback TB NDP on frequency domain corresponding to the RU tone set index is carried out. In step 4116, a step of calculating the RU tone set index based on the bandwidth of the TB Feedback NDP overlapping the STA's operating frequency range is carried out.

With an aggregated TB NDP solicited, a non-AP STA parking on any subchannel can be supported and the AP may generate a single NFRP Trigger frame for all non-AP STAs.

In the following paragraphs, a seventh embodiment of the present disclosure where bandwidth and position information in two different signal fields is used as frequency domain information to indicate a frequency domain within a STA's operating channel to transmit its feedback response is described.

Referring to FIG. 38, unlike the sixth embodiment, the UL BW subfield of the Common Info field may indicate a bandwidth of the solicited HE/EHT TB Feedback NDP that either overlaps the primary channel or does not overlap the primary channel, and the BW Extension subfield of the User Info field indicates the position of the solicited EHT TB Feedback NDP. The encoding of the BW Extension subfield is shown in Table 8 and the resolution of the subchannel is the bandwidth indicated in the UL BW subfield.

Table 8 shows various indications/meanings corresponding to different values of the BW Extension subfield.

| Value | Meaning |
|---|---|
| 0 | The 1^{st} lowest subchannel |
| 1 | The 2^{nd} lowest subchannel |
| 2 | The 3^{rd} lowest subchannel |
| 3 | The 4^{th} lowest subchannel |
| 4 | The 5^{th} lowest subchannel |
| 5 | The 6^{th} lowest subchannel |
| 6 | The 7^{th} lowest subchannel |
| 7 | The 8^{th} lowest subchannel |

Upon receipt of the EHT NFRP Trigger frame, associated non-AP STAs that satisfies feedback conditions will calculate RU tone set index based on values of AID, Starting AID and UL BW subfields. The non-AP STAs calculate their RU tone set indices based on the UL BW subfield using equation (2) and transmits on the assigned RU tone set of the indicated EHT TB Feedback NDP.

The non-AP STAs further calculate the total number of non-AP STAs that are scheduled to respond, and RU tone set index using AID, Starting AID and UL BW value indicated in the NFRP Trigger frame received over the operating channel (i.e., implicit offset based on SST setup is applied to control the index to a higher frequency).

With the BW Extension field, the AP can control the assigned RU tone set index to fall on a certain EHT TB Feedback NDP.

In an embodiment, the AP may transmit more than one EHT NFRP Trigger frames to different non-AP STAs in a PPDU using multi-user (MU) transmission (e.g., MU-MIMO and/or OFDMA) or in an A-PPDU. Each EHT NFRP Trigger frame may comprise different UL BW and BW Extension subfield value.

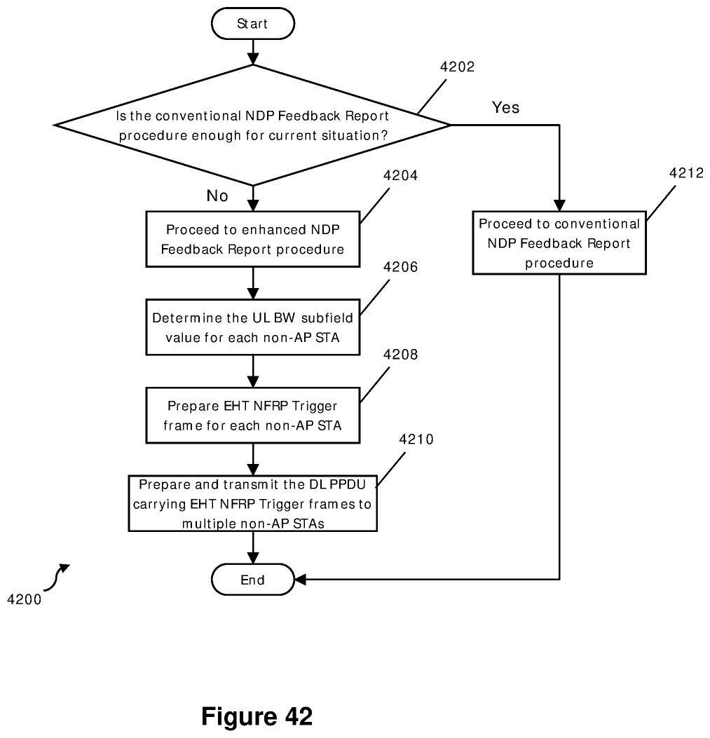

FIG. 42 depicts a flow diagram 4200 illustrating a process implemented by an AP in an enhanced NDP Feedback Report procedure according to the second example of the seventh embodiment of the present disclosure. The process starts with step 4202. In step 4202, a step of determining if the conventional NDP Feedback Report procedure is enough for the current situation. In an embodiment, in step 4202, the step of determining if the conventional NDP Feedback Report procedure is enough comprises a step of determining if all non-AP STAs can be supported in a single round of NDP Feedback Report procedure in either non-SST or SST scenario.

If it is determined that the convention NDP Feedback Report procedure is not enough, step 4204 is carried out; otherwise step 4212 is carried out. In step 4204, the process proceeds to an enhanced NDP Feedback Report procedure. In step 4206, a step of determining the UL BW subfield value for each non-AP STA is carried out. In step 4208, a step of preparing and generating EHT NFRP Trigger frame for each non-AP STA is carried out. In step 4210, a step of preparing and transmitting a DL PPDU carrying the EHT NFRP Trigger frames to multiple non-AP STAs is carried out, and the process may end. Returning to step 4204, if it is determined that the convention NDP Feedback Report procedure is enough for the current situation, the conventional NDP Feedback Report procedure proceeds in step 4212 and the process may end after that.

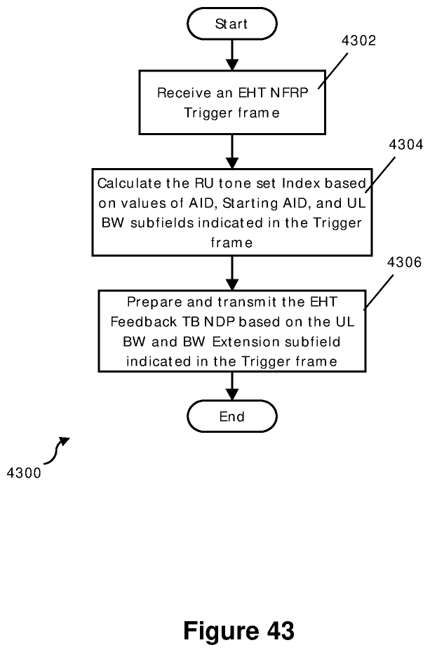

FIG. 43 depicts a flow diagram 4300 illustrating a process implemented by a STA in an enhanced NDP Feedback Report procedure according to the seventh embodiment of the present disclosure. The process starts with step 4302. In step 4302, an EHT NFRP Trigger frame is received. In step 4304, a step of calculating a RU tone set index based on values of AID, Starting AID and UL BW subfields indicated in the Trigger frame is carried out. In step 4310, a step preparing, generating and transmitting an EHT Feedback TB NDP based on the UL BW and BW Extension subfields indicated in the Trigger frame and the process may end.

Advantageously, the solution provided by the seventh embodiment require less change and is more flexible as compared to that of the sixth embodiment. However, the AP needs to generate different NFRP Trigger frame for different non-AP STAs.

In the following paragraphs, embodiments relating to two other variations of NFRP Trigger frame to include frequency domain information to indicate a frequency domain within a STA's operating channel to transmit its feedback response are described.

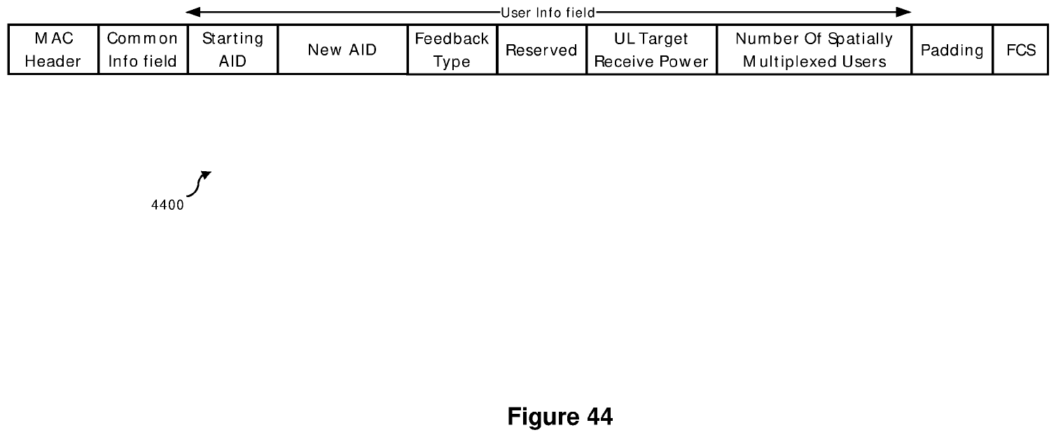

FIG. 44 depicts an example format of an EHT NFRP Trigger frame 4400 according to an embodiment of the present disclosure. The EHT NFRP Trigger frame 4400 comprises a MAC Header (Frame Control field, Duration field, RA field and TA field), a Common Info field, a User Info field, a Padding field and a FCS field. The User Info field comprises a Starting AID subfield, a New AID subfield, a Feedback Type subfield, a UL Target Receive Power subfield and a Number Of Spatially Multiplexed Users subfield. In this variation, the New AID subfield in the User Info field indicates a new AID assigned to a non-AP STA.

The new AID may either take effect only inside the NDP Feedback Report procedure, or until association/reassignment. The non-AP STA receiving the EHT NFRP Trigger frame indicating the New AID value will determine whether it satisfies feedback conditions and calculate the RU tone set index using the new AID value instead of the old one. Alternatively, the AP may send a AID Switch Response frame to indicate such a new AID. The AP will decide the new AID assignment is successful only if a feedback response from the non-AP STA is received in the EHT-LTF field of the EHT TB Feedback NDP transmitted by the non-AP STA.

On the other hand, it is noted that, in an NDP Feedback Report procedure, it is possible that AIDs of a BSS are not contiguous. Such contiguous BSS AIDs may be accidental. For example, there are initially 8 STAs with AID 1-8 associated with the BSS, STA with AID 3 leaves and get unassociated then in the BSS, position in AID 3 becomes vacant. The contiguous BSS AIDs may be non-accidental. For example, in Multi-link transmission, AIDs are assigned non-contiguously. A first group of STAs working on 2.4 GHz are assigned with AID 1-50 whereas a second group of STAs working on 5 GHz are assigned with AID 1001-1050.

In a high density environment, there could be a lot of vacant AIDs in the BSS and lead to holes in the EHT-LTF field of EHT TB Feedback NDP.

Therefore, instead of only indicating the starting AID, the AP may further indicate the scheduled AIDs (e.g., provide a list of AIDs scheduled to respond) concretely in an NFRP Trigger frame. There are two options to achieve this: (i) Option 1: to include multiple User Info fields in the NFRP Trigger frame; and Option 2: to indicate the starting AID and a bitmap for scheduled AIDs.

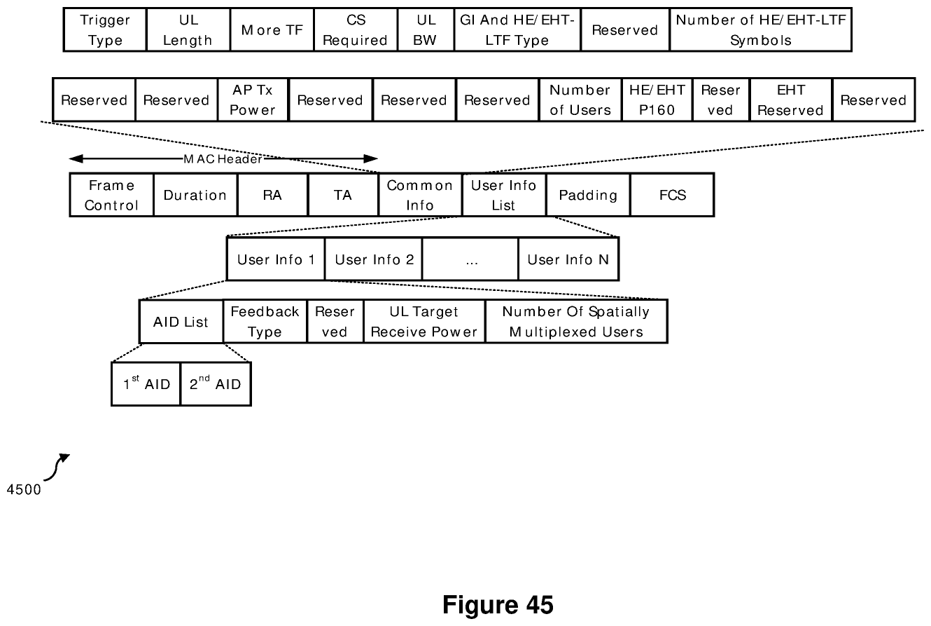

FIG. 45 depicts an example format of an EHT NFRP Trigger frame 4500 according to an embodiment of the present disclosure. The EHT Trigger frame 4500 is used for variation Option 1 above to include multiple User Info fields. The EHT Trigger frame 4500 comprises a Frame Control field, a Duration field, a RA field, a TA field, a Common Info field, a User Info List field, a Padding field and a FCS field. The Frame Control field, the Duration field, the RA field and the TA field may be grouped as MAC header. The Common field consists of a Trigger Type subfield, a UL Length subfield, a More TF subfield, a CS Required subfield, a UL BW subfield, a GI And HE-LTF Type subfield, a Number OF HE/EHT-LTF Symbols subfield, an AP Tx Power subfield, a Number of Users subfield, a HE/EHT P160 subfield and an EHT Reserved subfield. The User Info List field comprises multiple User Info field, each comprising an AID List field subfield, a Feedback Type subfield, a UL Target Receive Power subfield and a Number Of Spatially Multiplexed Users subfield. The number of Users subfield in the Common Info field indicates the number of User Info fields included in the User Info List field. The AID List subfield in each User Info field comprises a few AID fields such as 1st AID subfield and a 2nd AID subfield. This is because there are not enough bits in a single User Info field (40 bits). The AID List subfield can be used to indicate the STAs AIDs scheduled to respond to the NFRP Trigger frame.

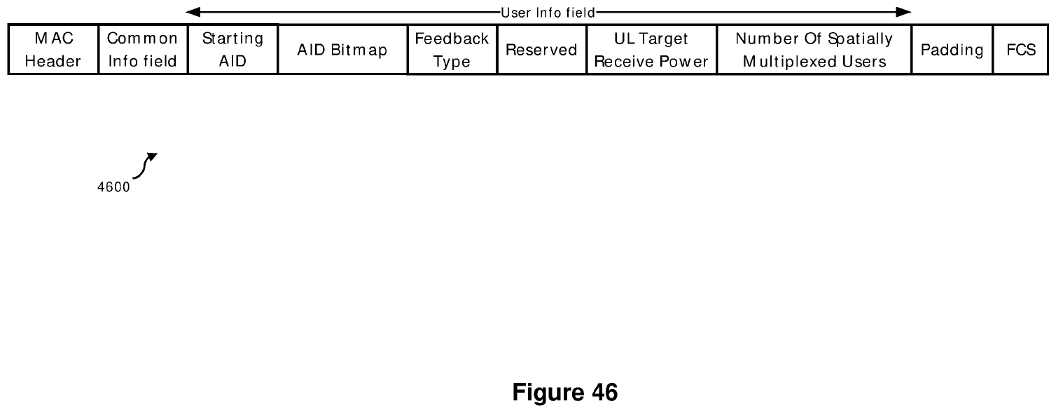

FIG. 46 depicts an example format of an EHT NFRP Trigger frame 4600 according to another embodiment of the present disclosure. The EHT Trigger frame 4600 is used for variation Option 2 above to include the Starting AID and a bitmap for other AIDs. The EHT NFRP Trigger frame 4600 comprises a MAC Header (Frame Control field, Duration field, RA field and TA field), a Common Info field, a User Info field, a Padding field and a FCS field. The User Info field comprises a Starting AID subfield, a AID Bitmap subfield, a Feedback Type subfield, a UL Target Receive Power subfield and a Number Of Spatially Multiplexed Users subfield. The (AID—Starting AID)^{th} bit in the AID bitmap subfield indicates whether the non-AP with the corresponding AID is scheduled to respond and the RU tone index.

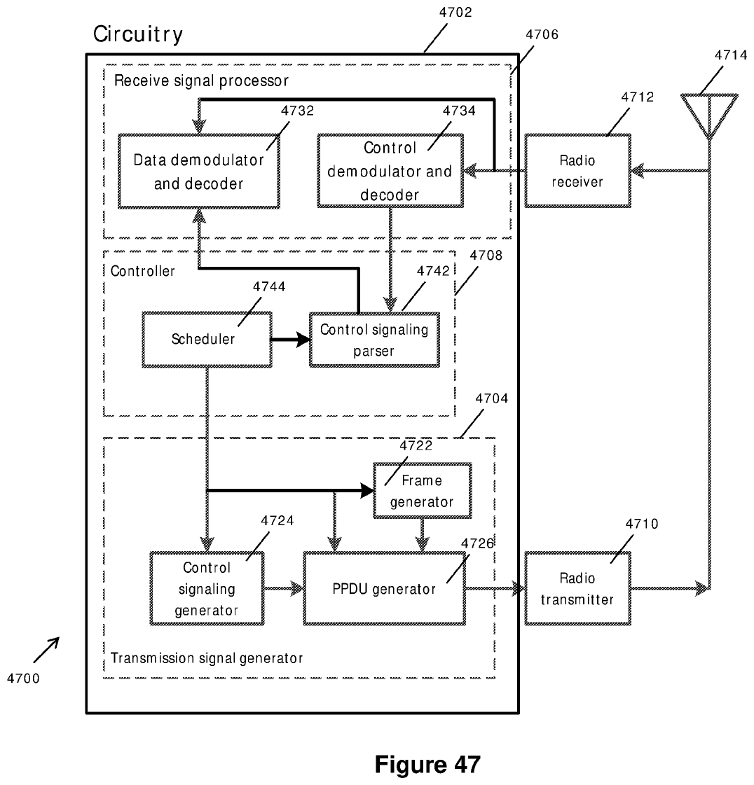

FIG. 47 depicts a configuration of a communication apparatus, for example an AP, according to various embodiments of the present disclosure. Similar to the schematic example of the communication apparatus 1200 shown in FIG. 12, the communication apparatus 4700 includes circuitry 4702, at least one radio transmitter 4710, at least one radio receiver 4712, at least one antenna 4714 (for the sake of simplicity, only one antenna is depicted in FIG. 47). The circuitry 4702 may include at least one controller 4708 for use in software and hardware aided execution of tasks that the controller 4708 is designed to perform communication for a feedback response transmission in an indicated frequency domain. The circuitry 4702 may further include a transmission signal generator 4704 and a receive signal processor 4706. The at least one controller 4708 may control the transmission signal generator 4704 and the receive signal processor 4706. The transmission signal generator 4704 may include a frame generator 4722, a control signalling generator 4724, and a PPDU generator 4726. The frame generator 4722 may generate MAC frames, e.g., HE/EHT null data packet (NDP) Feedback Report Poll (NFRP) Trigger frames described in various embodiments in the present disclosure. The control signalling generator 4724 may generate control signalling fields of PPDUs to be generated (e.g., HE/EHT-SIG fields of HE/EHT PPDUs comprising HE/EHT NFRP Trigger frames). The PPDU generator 4726 may generate PPDUs (e.g., HE/EHT PPDUs comprising HE/EHT NFRP Trigger frames).

The receive signal processor 4706 may include a data demodulator and decoder 4734, which may demodulate and decode data portions of the received signals (e.g., HE/EHT-LTF of HE/EHT TB Feedback NDPs). The receive signal processor 4706 may further include a control demodulator and decoder 4734, which may demodulate and decode control signaling portions of the received signals (e.g., HE-SIG-A/U-SIG fields of HE/EHT TB Feedback NDPs). The at least one controller 4708 may include a control signal parser 4742 and a scheduler 4744. The scheduler 4744 may determine RU information and user-specific allocation information for allocations of downlink SU or MU transmissions and triggering information for allocations of uplink MU transmissions. The control signal parser 4742 may analyse the control signaling portions of the received signals and the triggering information for allocations of uplink MU transmissions shared by the scheduler 4744 and assist the data demodulator and decoder 4732 in demodulating and decoding the data portions of the received signals (e.g., HE/EHT-LTF of HE/EHT TB Feedback NDPs).

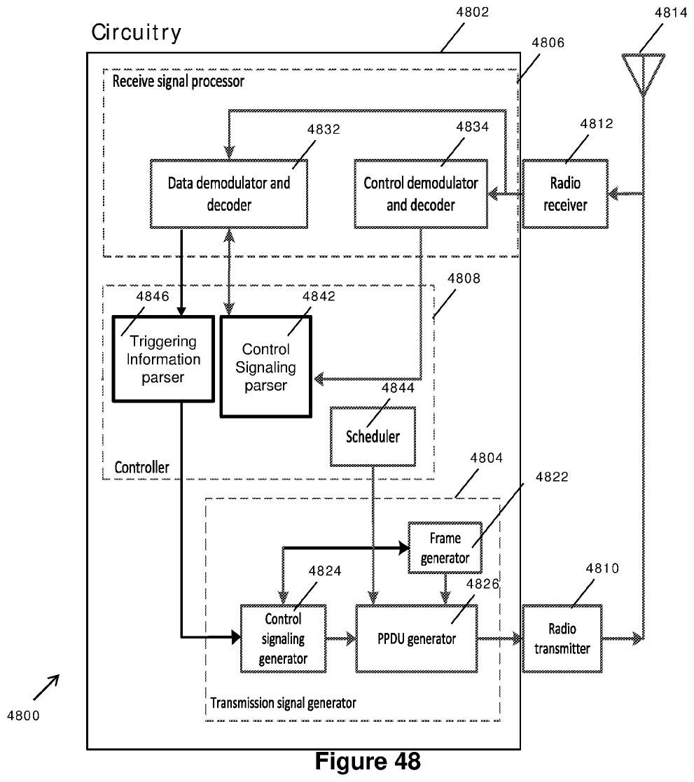

FIG. 48 depicts a configuration of a communication apparatus, for example a STA, according to various embodiments of the present disclosure. Similar to the schematic example of communication apparatus 1200 shown in FIG. 12, the communication apparatus 4800 includes circuitry 4802, at least one radio transmitter 4810, at least one radio receiver 4812, at least one antenna 4814 (for the sake of simplicity, only one antenna is depicted in FIG. 48). The circuitry 4802 may include at least one controller 4808 for use in software and hardware aided execution of tasks that the controller 4808 is designed to perform communication for a feedback response transmission in an indicated frequency domain. The circuitry 4802 may further include a receive signal processor 4804 and a transmission signal generator 4806. The at least one controller 4808 may control the receive signal processor 4804 and the transmission signal generator 4806. The receive signal processor 4804 may include a data demodulator and decoder 4832 and a control demodulator and decoder 4834. The control demodulator and decoder 4834 may demodulate and decode control signaling portions of the received signals (e.g., HE/EHT NFRP Trigger frames described in various embodiments in the present disclosure). The data demodulator and decoder 4832 may demodulate and decode data portions of the received signals (e.g., data fields of HE/EHT PPDUs comprising HE/EHT NFRP Trigger frames) according to RU information and user-specific allocation information of its own allocations.

The at least one controller 4808 may include a control signal parser 4842, and a scheduler 4844 and a trigger information parser 4826. The control signal parser 4842 may analyze the control signaling portions of the received signals (e.g. HE/EHT-SIG fields of HE/EHT NFRP Trigger frames) and assist the data demodulator and decoder 4832 in demodulating and decoding the data portions of the received signals (e.g., data fields of HE/EHT PPDUs comprising HE/EHT NFRP Trigger frames). The triggering information parser 4848 may analyze the triggering information for its own uplink allocations from the received triggering frames contained in the data portions of the received signals. The transmission signal generator 4804 may include a control signalling generator 4824, which may generate control signalling fields of PPDUs to be generated (e.g. HE/EHT-SIG fields of HE/EHT PPDUs comprising HE/EHT TB Feedback NDPs). The transmission signal generator 4804 may further include a PPDU generator 4826, which generate PPDUs (e.g. HE/EHT TB Feedback NDPs). The transmission signal generator 4804 may further include a frame generator 4822 may generate MAC frames.

As described above, the embodiments of the present disclosure provide an advanced communication system, communication methods and communication apparatuses for a feedback response transmission in an indicated frequency domain in MIMO WLAN networks and improve spectral efficiency in MIMO WLAN networks.

The present disclosure can be realized by software, hardware, or software in cooperation with hardware. Each functional block used in the description of each embodiment described above can be partly or entirely realized by an LSI such as an integrated circuit, and each process described in each embodiment may be controlled partly or entirely by the same LSI or a combination of LSIs. The LSI may be individually formed as chips, or one chip may be formed so as to include a part or all of the functional blocks. The LSI may include a data input and output coupled thereto. The LSI here may be referred to as an IC, a system LSI, a super LSI, or an ultra LSI depending on a difference in the degree of integration. However, the technique of implementing an integrated circuit is not limited to the LSI and may be realized by using a dedicated circuit, a general-purpose processor, or a special-purpose processor. In addition, a FPGA (Field Programmable Gate Array) that can be programmed after the manufacture of the LSI or a reconfigurable processor in which the connections and the settings of circuit cells disposed inside the LSI can be reconfigured may be used. The present disclosure can be realized as digital processing or analogue processing. If future integrated circuit technology replaces LSIs as a result of the advancement of semiconductor technology or other derivative technology, the functional blocks could be integrated using the future integrated circuit technology. Biotechnology can also be applied.

The present disclosure can be realized by any kind of apparatus, device or system having a function of communication, which is referred to as a communication apparatus.

Some non-limiting examples of such a communication apparatus include a phone (e.g. cellular (cell) phone, smart phone), a tablet, a personal computer (PC) (e.g. laptop, desktop, netbook), a camera (e.g. digital still/video camera), a digital player (digital audio/video player), a wearable device (e.g. wearable camera, smart watch, tracking device), a game console, a digital book reader, a telehealth/telemedicine (remote health and medicine) device, and a vehicle providing communication functionality (e.g. automotive, airplane, ship), and various combinations thereof.

The communication apparatus is not limited to be portable or movable, and may also include any kind of apparatus, device or system being non-portable or stationary, such as a smart home device (e.g. an appliance, lighting, smart meter, control panel), a vending machine, and any other “things” in a network of an “Internet of Things (IoT)”.

The communication may include exchanging data through, for example, a cellular system, a wireless LAN system, a satellite system, etc., and various combinations thereof.

The communication apparatus may comprise a device such as a controller or a sensor which is coupled to a communication device performing a function of communication described in the present disclosure. For example, the communication apparatus may comprise a controller or a sensor that generates control signals or data signals which are used by a communication device performing a communication function of the communication apparatus.

The communication apparatus also may include an infrastructure facility, such as a base station, an access point, and any other apparatus, device or system that communicates with or controls apparatuses such as those in the above non-limiting examples.

It will be understood that while some properties of the various embodiments have been described with reference to a device, corresponding properties also apply to the methods of various embodiments, and vice versa.

It will be appreciated by a person skilled in the art that numerous variations and/or modifications may be made to the present disclosure as shown in the specific embodiments without departing from the spirit or scope of the disclosure as broadly described. The present embodiments are, therefore, to be considered in all respects illustrative and not restrictive.

| | 80 MHz | | 40 MHz | | 20 MHz | |
|---|---|---|---|---|---|---|
| | Tones if | Tones if | Tones if | Tones if | Tones if | Tones if |
| | FEED- | FEED- | FEED- | FEED- | FEED- | FEED- |
| RU_TONE_SET_IN- | BACK_STA- | BACK_STA- | BACK_STA- | BACK_STA- | BACK_STA- | BACK_STA- |
| DEX | TUS is 1 | TUS is 0 | TUS is 1 | TUS is 0 | TUS is 1 | TUS is 0 |
| 1 | Use 20 MHz | Use 20 MHz | Use 20 MHz | Use 20 MHz | −113, −77, −41, | −112, −76, −40, |
| 2 | FEEDBACK_STA- | FEEDBACK_STA- | FEEDBACK_STA- | FEEDBACK_STA- | 6, 42, 78 | 7, 43, 79 |
| . . . | TUS = 1 | TUS = 0 | TUS = 1 | TUS = 0 | −111, −75, −39, | −110, −74, −38, |
| 18 | Subcarrier | Subcarrier | Subcarrier | Subcarrier | 8, 44, 80 | 9, 45, 81 |
| | Indices − 384 | Indices − 384 | Indices − 128 | Indices − 128 | . . . | . . . |
| | | | | | −79, −43, −7, | −78, −42, −6, |
| 19-36 | Use 20 MHz | Use 20 MHz | Use 20 MHz | Use 20 MHz | 40, 76, 112 | 41, 77, 113 |
| | FEEDBACK_STA- | FEEDBACK_STA- | FEEDBACK_STA- | FEEDBACK_STA- | | |
| | TUS = 1 | TUS = 0 | TUS = 1 | TUS = 0 | | |
| | Subcarrier | Subcarrier | Subcarrier | Subcarrier | | |
| | Indices − 128 | Indices − 128 | Indices + 128 | Indices + 128 | | |
| 37-54 | Use 20 MHz | Use 20 MHz | Use 20 MHz | Use 20 MHz | | |
| | FEEDBACK_STA- | FEEDBACK_STA- | FEEDBACK_STA- | FEEDBACK_STA- | | |
| | TUS = 1 | TUS = 0 | TUS = 1 | TUS = 0 | | |
| | Subcarrier | Subcarrier | Subcarrier | Subcarrier | | |
| | Indices + 128 | Indices + 128 | Indices + 128 | Indices + 128 | | |
| 55-72 | Use 20 MHz | Use 20 MHz | | | | |
| | FEEDBACK_STA- | FEEDBACK_STA- | | | | |
| | TUS = 1 | TUS = 0 | | | | |
| | Subcarrier | Subcarrier | | | | |
| | Indices + 384 | Indices + 384 | | | | |

1. A communication apparatus comprising:
circuitry, which, in operation, generates a signal that solicits a feedback response; and
a transmitter, which, in operation, transmits the generated signal to one or more peer communication apparatuses,
wherein the generated signal comprises frequency domain information indicating a frequency domain used for transmitting the feedback response within an operating channel of the one or more peer communication apparatuses.

2. The communication apparatus of claim 1, wherein the feedback response is carried in one trigger-based (TB) feedback null data packet (NDP), and the frequency domain information comprises an adjustment of a resource unit (RU) tone set index assigned to the one or more peer communication apparatuses to correspond to the frequency domain.

3. The communication apparatus of claim 2, wherein the frequency domain information comprises a parameter used in a calculation phase during which the adjustment of the assigned RU tone set index is calculated.

4. The communication apparatus of claim 3, wherein the parameter comprises an offset value used for the adjustment of the assigned RU tone set index to correspond to the frequency domain.

5. The communication apparatus of claim 3, wherein the parameter comprises a self-adaptive procedure indicator indicating an allowance for the one or more peer communication apparatuses to self-adjust the assigned RU tone set index to correspond to the frequency domain or another frequency domain close to the frequency domain within the operating channel of the one or more peer communication apparatuses.

6. The communication apparatus of claim 1, wherein the feedback response is carried in more than one TB feedback NDP, and the generated signal comprises a field indicating information to determine which one of the more than one TB feedback NDP to use for the transmission of the feedback response.

7. The communication apparatus of claim 6, wherein the field indicates a bandwidth of the one of the more than one TB feedback NDP overlapping with the primary channel.

8. The communication apparatus of claim 6, wherein the field indicates a bandwidth and a position of the one of the more than one TB feedback NDP not overlapping with the primary channel.

9. The communication apparatus of claim 6, wherein the field indicates a bandwidth of the one of the more than one TB feedback NDP and the generated signal comprises another signal field indicating a position of the one of the more than one TB feedback NDP.

10. The communication apparatus of claim 1, wherein the generated signal comprises a new identifier assigned to the one or more peer communication apparatuses.

11. The communication apparatus of claim 1, wherein the generated signal comprises an identifier or an identifier bitmap for identifying only the one or more peer communication apparatuses scheduled to transmit the feedback response.

12. A peer communication apparatus comprising:
a receiver, which, in operation, receive a signal to solicit a feedback response, the signal comprising frequency domain information indicating a frequency domain used for transmitting the feedback response within an operating channel of the peer communication apparatus;
circuitry, which, in operation, process the signal and generate the feedback response; and
a transmitter, which, in operation, transmit the feedback response in the frequency domain.

13. The peer communication apparatus of claim 12, wherein the feedback response comprises a trigger-based (TB) feedback null data packet (NDP) and the frequency domain information comprises an adjustment of an resource unit (RU) tone set index assigned to the peer communication apparatus to correspond to the frequency domain.

14. The peer communication apparatus of claim 13, wherein the frequency domain information is a parameter; and, during a calculation phase to calculate the assigned RU tone set, the circuitry is configured to calculate the adjustment of the assigned RU tone set index using the parameter.

15. The peer communication apparatus of claim 14, wherein the parameter comprises an offset value used for the adjustment of the assigned RU tone set index to correspond to the frequency domain.

16. The peer communication apparatus of claim 14, wherein the parameter comprises a self-adaptive procedure indicator indicating an allowance to self-adjust the assigned RU tone set index, the circuitry is configured to adjust the assigned RU tone set index to correspond to the frequency domain.

17. The peer communication apparatus of claim 13, wherein the signal comprises a field indicating a bandwidth; and the circuitry is configured to further determine if the peer communication apparatus is scheduled to transmit the feedback response based on the bandwidth.

18. A communication method implemented by a communication apparatus comprising:
generating a signal used for soliciting a feedback response;
transmitting the signal to one or more peer communication apparatuses, the signal comprising frequency domain information indicating a frequency domain used for transmitting the feedback response within an operating channel of the peer communication apparatuses.

19. A communication method implemented by a peer communication apparatus comprising:
receiving a signal soliciting a feedback response, the signal comprising frequency domain information indicating a frequency domain used for transmitting the feedback response within an operating channel of the peer communication apparatus;
processing the signal and generating the feedback response; and
transmitting the feedback response in the frequency domain.
